(19) United States
(12) Patent Application Publication
(10) Pub. No.: US 2007/0143349 A1
(43) Pub. Date: Jun. 21, 2007

(54) Information processing apparatus, file management method, and file management program

(76) Inventor: Kyouji Iwasaki, Tokyo (JP)

Correspondence Address: RABIN & Berdo, PC, 1101 14TH STREET, NW, SUITE 500, WASHINGTON, DC, 20005, US

(21) Appl. No.: 10/588,900

(22) PCT Filed: Feb. 10, 2005
(86) PCT No.: PCT/JP05/02028

§ 371 Date: Aug. 9, 2006

(30) Foreign Application Priority Data
Feb. 10, 2004 (JP) 2004-033017

(51) Int. Cl. G06F 17/30

(52) U.S. Cl. 707/200

(57) ABSTRACT

An information processing apparatus causes a display unit to display a save screen for saving a file to a memory under control of a CPU. When a condition to be assigned to the file is specified via the save screen, the information processing apparatus assigns the specified condition to path information of the file and causes the memory to save the file. Moreover, the information processing apparatus causes the display unit to display a seek screen for seeking and displaying the file saved to the memory under control of the CPU. When a condition of the file to be sought through the seek screen is specified, the information processing apparatus recognizes the path information of the file saved to the memory as a condition set in which the selection sequence may be changed and each condition is an arbitrary selection item, seeks an objective file corresponding to the calculation result of the condition set according to the specified condition, and causes the display unit to display the objective files as the seek result.

### TECHNICAL FIELD

This invention relates to an information processing apparatus, a file management method, and a file management program for saving a file in a predetermined saving means and for displaying by seeking a file saved to the saving means.

### BACKGROUND ART

In a recent information processing apparatus such as a personal computer or the like, the number of storable files goes on increasing along with the quest for increased memory capacity.

In such information processing apparatuses described above, a plurality of folders (directories) saving individual files are hierarchized in a tree form and mapped to manage the individual files. With respect to a newly created file, a user inputs a file name that specifies a folder as a file destination, thereby saving the new file in a predetermined folder. At this time, this file is managed as a series of path information composed of the plurality of folder names and file names that are in a tree form connecting a folder corresponding to a root directory to the folder in which this file is saved. To save a file, therefore, the user arbitrarily sets such a path system in advance, indicating the designation of the file, and specifies the designation according to contents of the file while inputting a file name by which the contents of the file can be guessed in many cases so that the file is easily sought.

For example, Japanese Patent Application Laid-Open No. 2002-99455 has been proposed to facilitate file management by solving complicated specification of the file designation, as described above.

Japanese Patent Application Laid-Open No. 2002-99455 is one example of related art.

To be more precise, a file saving device for saving the file by setting the file designation is disclosed in Japanese Patent Application Laid-Open No. 2002-99455. The file saving device creates and edits attribute information on the file, and makes the setting in a manner to use the created and edited attribute information as a file designation, thereby saving the file in the file distribution indicated by the created and edited attribute information according to the setting. That is, this file saving device directly uses the attribute information on the file to be saved, as the file designation or the file name, thereby setting the file designations or the file names systematically to facilitate the file management.

In the case of seeking a target file under the conventional file management system based on a hierarchical structure in a tree form, folders existing between the folder corresponding to the root directory and the folder saving the target file cannot be skipped. Therefore, in the case of forgetting even one of the folder names existing between the folder corresponding to the root directory and the folder saving the file, the user is required to individually confirm the folder names even where he remembers those folder names, so that this conventional file management system leads to a situation where the seeking operation becomes difficult.

Furthermore, under the conventional file management system, the user cannot extract only the files having substantially the same attribute as that of the target file from files saved to another folder other than the folder saving the target file. Thus, in the case where classification of the folder is different from the desired classification for extracting the file, the user is required to check contents of each of the folders to seek the file corresponding to the target, so that this conventional file management system leads to a situation where the user is required to make enormous amounts of effort.

Furthermore, under the conventional file management system, one single file cannot be saved to multiple folders at the same time. Therefore, even in the case where a file corresponds to items of two or more folders, it is required to save the file in either one of the folders or to save the plurality of files in the plurality of folders as different files separately. In the latter case, the files having the same contents, which are saved to different files, have nothing in common and are recognized as separate files.

Furthermore, under the conventional file management system, contents of two or more folders cannot be displayed at the same time by using a software program for file browsing such as Explorer for displaying the hierarchical structure of the folders. Therefore, in the case of seeking the target file, it is required to seek the folder saving this target file accurately.

Yet further, a large number of organizations such as a company and the like have introduced groupware to promote shared use of information in recent years. Under the conventional file management system, however, it is quite difficult to standardize a tree design in the organization and the like where the plurality of users belong since the user arbitrarily designs the tree. Therefore, users other than the user who saved a file have great difficulty in finding the saved file, so that a present situation is such that shared use of information is impractical in reality.

As described above, the conventional file management system is bound by such a stereotype that a file is to be managed in a saving area such as folders forming a hierarchical structure in a tree form, thereby having difficulty in managing the file in association with an increase in the number of files.

### DISCLOSURE OF THE INVENTION

This invention is accomplished in consideration of the above situation, and it is an objective of the invention to provide an information processing apparatus, a file management method, and a file management program capable of managing files with ease from the various viewpoints by shaking off a concept of the conventional file management based on a hierarchical structure in a tree form and by constructing a new mechanism of a file management.

According to this invention for achieving the aforementioned objects, an information processing apparatus includes a save screen display controlling section for displaying on a display section a save screen for saving a file to a predetermined saving section, a first condition specifying section for specifying a condition to be assigned to the file via the save screen displayed on the display section, a save processing section for assigning each condition assigned by the first condition specifying section to path information of the file and for saving the file to the saving section, a seek screen display controlling section for displaying on the display section a seek screen for seeking and displaying the file saved to the saving section, a second condition specifying section for specifying a condition of the file as a seek objective via the seek screen displayed on the display section, a seek processing section for recognizing the path information of the file saved to the saving section, as such a condition set as allowing a selection sequence to be changeable and as having each condition set to an arbitrary selection item, the seek processing section for seeking for an objective file corresponding to a calculation result of the condition set based on a condition specified by the second condition specifying section, and a result display controlling section for displaying on the display section the objective file as a seek result by the seek processing section.

With the information processing apparatus according to this invention, the files can be appropriately organized without forming a hierarchical structure in a tree shape with conventional folders as an essential selection item which sets a selection sequence to unchangeable, by recognizing the path information of the file as such a condition set as allowing a selection sequence to be changeable and as having each condition set to an arbitrary selection item, so that such the files can be sought based on a concept such as a produce of set (intersection), a union of set, a difference of sets, and the like, which are conventionally considered as impossible.

To be more specific, in the information processing apparatus according to this invention, the save screen is provided with a first keyword-only operation element for specifying as a condition a keyword arbitrarily set by a user, wherein the seek screen is provided with a second keyword-only operation element for specifying as a condition a keyword corresponding to the first keyword-only operation element displayed on the save screen, wherein the save processing section assigns as a condition a keyword registered in the first keyword-only operation element, specified via the first condition specifying section, to the path information of the file, and saves the file to the saving section, and wherein the seek processing section seeks the objective file corresponding to the computation result of the condition set, based on a keyword as a condition registered in the second keyword-only operation element, specified via the second condition specifying section.

Thus, the information processing apparatus according to this invention enables the user to easily seek the corresponding file from among various conditions based on one or more keywords arbitrarily set by himself.

Herein, it is desirable to register a fixed keyword uninfluenced by a time factor and a movable keyword registered influenced by a time factor in both the first keyword-only operation element and the second keyword-only operation keyword.

In the information processing apparatus according to this invention, the save screen is provided with a first management time-only operation element for specifying as a condition a management time of the file, wherein the seek screen is provided with a second management time-only operation element for specifying as a condition a management time corresponding to the first management time-only operation element displayed on the save screen, wherein the save processing section assigns as a condition a management time registered in the first management time-only operation element specified via the first condition specifying section, to the path information of the file, and saves the file to the saving section, and wherein the seek processing section seeks the objective file corresponding to the calculation result of the condition set, based on a management time as a condition registered in the second management time-only operation element specified via the second condition specifying section. Herein, an update time of the file is basically used as the management time.

Thus, the information processing apparatus according to this invention enables the user to easily seek the corresponding file from among various conditions based on the management time which the file itself has.

In the meantime, it is desirable that the first management time-only operation element and the second management time-only operation element are respectively configured with such a plurality of time division as arranged in parallel and as specifying a range of the management time.

In the information processing apparatus according to this invention, furthermore, the save screen may be provided with a deselection-only operation element for specifying a condition for displaying all files as the seek result regardless of specification of the management time by the first management time-only operation element, wherein the save processing section assigns as a condition a predetermined character string to the path information of the file according to selection of the deselection-only operation element via the first condition specifying section, and saves the file to the saving section, and wherein the seek processing section seeks as the objective file a file having the path information assigned with the character string, regardless of the management time as a condition registered in the second management time-only operation element, specified via the second condition specifying section.

Furthermore, in the information processing apparatus according to this invention, the save screen may be provided with a non-display-only operation element for specifying a condition for preventing display of a file as the seek result regardless of specification of the management time by the first management time-only operation element, wherein the save processing section assigns as a condition a predetermined character string to the path information of the file according to selection of the non-display-only operation element via the first condition specifying section, and saves the file to the saving section, and wherein the seek processing section excludes the file having the path information assigned with the character string from seek candidates regardless of the management time as a condition registered in the second management time-only operation element, specified via the second condition specifying section.

Yet further, in the information processing apparatus according to this invention, it is desirable that the seek screen is provided with a non-display reset operation element for redisplaying the file excluded by the seek processing section from the seek candidates based on the character string assigned to the path information.

In the information processing apparatus according to this invention, furthermore, the save screen is provided with is provided with a first type-only operation element for specifying a type of the file as a condition, wherein the seek screen is provided with a second type-only operation element for specifying as a condition a type corresponding to the first type-only operation element displayed on the save screen, wherein the save processing section identifies as a condition an extension registered in the path information of the file based on a type of the file registered in the first type-only operation element, specified via the first condition specifying section, and saves the file to the saving section, and wherein the seek processing section seeks the objective file with reference to the extension registered in the path information of the file, based on a type of the file as a condition registered in the second type-only operation element, specified via the second condition specifying section.

Thus, the information processing apparatus according to this invention enables the user to easily seek the corresponding file from among various conditions based on a type of the file as well.

In the information processing apparatus according to this invention, furthermore, it is desirable that the save processing section assigns information indicating existence of a second file to be attached, to the path information of the first file, and saves the first file to the saving section while saving the second file to a specific saving area in the saving section.

Furthermore, the information processing apparatus can handle each of sent and received emails as an independent file. In this case, the information processing apparatus handles each of sent and received emails as an independent file, saves an email file to the saving section, and includes an email screen display controlling section for displaying on the display section an email screen for seeking and displaying the email file saved to the saving section, wherein the save processing section assigns each condition specified for the email file by the first condition specifying section, to the path information of the email file via the email screen displayed on the display section, and saves the email file to the saving section, and wherein the seek processing section seeks an objective email file corresponding to a calculation result of a condition set via the email screen displayed on the display section, based on a condition specified by the second condition specifying section.

According to this invention for achieving the aforementioned objects, a file management method includes a save screen display controlling step for displaying on a display section a save screen for saving a file to a predetermined saving section, a first condition specifying step for specifying a condition to be assigned to the file via the save screen displayed on the display section, a save processing step for assigning each condition specified at the first condition specifying step to path information of the file and for saving the file to the saving section, a seek screen display controlling step for displaying on the display section a seek screen for seeking and displaying the file saved to the saving section, a second condition specifying step for specifying a condition of the file as a seek objective via the seek screen displayed on the display section, a seek processing step for recognizing the path information of the file saved to the saving section, as such a condition set as allowing a selection sequence to be changeable and as having each condition set to an arbitrary selection item, the seek processing step for seeking an objective file corresponding to a calculation result of the condition set based on a condition specified at the second condition specifying step, and a result display controlling step for displaying on the display section the objective file as a seek result at the seek processing step.

According to this invention for achieving the aforementioned objects, a file management program executable by a computer includes a save screen display controlling process for displaying on a display section a save screen for saving a file to a predetermined saving section, a first condition specifying process for specifying a condition to be assigned to the file via the save screen displayed on the display section, a save process for assigning each condition specified in the first condition specifying process to path information of the file and for saving the file to the saving section, a seek screen display controlling process for displaying on the display section a seek screen for seeking and displaying the file saved to the saving section, a second condition specifying process for specifying a condition of the file as a seek objective via the seek screen displayed on the display section, a seek process for recognizing the path information of the file saved to the saving section, as such a condition set as allowing a selection sequence to be changeable and as having each condition set to an arbitrary selection item, the seek process for seeking an objective file corresponding to a calculation result of the condition set based on a condition specified in the second condition specifying process, and a result display controlling process for displaying on the display section the objective file as a seek result in the seek process.

With the information file management method and the file management program according to this invention, the files can be appropriately organized without forming a hierarchical structure in a tree shape with conventional folders as an essential selection item which sets a selection sequence to unchangeable, by recognizing the path information of the file as such a condition set as allowing a selection sequence to be changeable and as having each condition set to an arbitrary selection item, so that such the files can be sought based on a concept such as a produce of set (intersection), a union of set, a difference of sets, and the like, which are conventionally considered as impossible.

As described above, according to this invention, the corresponding file can be sought from among various conditions easily and accurately by shaking off a concept of conventional file management based on a fixed hierarchical structure in a tree form and by adopting a concept of a condition set to perform a file management in which the path information is recognized as a condition set, so that the user can be provided with remarkably high convenience.

### BRIEF DESCRIPTION OF THE DRAWINGS

FIG. 1 is a view illustrating a concept of a stock control and a flow control;

FIG. 2 is a view illustrating a concept of saving information as an object sought arbitrarily by not discarding but omitting the information from management objectives;

FIG. 3 is a view illustrating a state of a conventional file management system in which a file is saved to a folder forming a hierarchical structure in a tree form formed in accordance with path information, and an area saving the file is managed;

FIG. 4 is a view illustrating a state of the conventional file management system in which a sequence of selecting the folder is unchangeable;

FIG. 5 is a view illustrating a state where path information is recognized as a condition set in this invention;

FIG. 6 (a) is a view illustrating an example of a Venn diagram in the case where each of the folders is taken as a set under the conventional file management system;

FIG. 6 (b) is a view illustrating an example of a Venn diagram in the case where each of the folders is taken as a set under the file management system according to this invention, in which the path information is recognized as a condition set;

FIG. 7 (a) is a view illustrating such a state that the file is sought based on a concept of a product of sets (intersection) under the file management system according to the present invention, in which the path information is recognized as a condition set;

FIG. 7 (b) is a view illustrating such a state that the file is sought based on a concept of a union of sets under the file management system according to the present invention, in which the path information is recognized as a condition set;

FIG. 7 (C) is a view illustrating such a state that the file is sought based on a concept of a difference of sets under the file management system of the present invention, in which the path information is recognized as a condition set;

FIG. 8 (a) is a view illustrating such a state that a predetermined classification is made for the folders under the conventional film management system;

FIG. 8 (b) is a view illustrating such a state that the same classification is made to the folders under the film management system according to the present invention, in which a concept of the condition set is adopted;

FIG. 9 (a) is a view illustrating a state of the conventional file management, in which the folders classified based on different standards happen to exist in the same hierarchy in many cases and a personal point of view of a person who saved the file has a great effect on the classification sequence;

FIG. 9 (b) is a view illustrating a state of the file management system according to this invention in which a concept of the condition set is adopted and the classification shown in FIG. 9 (a) is made based on the condition set;

FIG. 10 (a) is a view illustrating a concept of a save screen under the file management system according to the invention, in which a concept of the condition set is adopted;

FIG. 10 (b) is a view illustrating a concept of a seek screen under the file management system according to the invention, in which a concept of the condition set is adopted;

FIG. 11 is a block diagram illustrating a structure of an information processing apparatus according to embodiments of the invention;

FIG. 12 is a view illustrating a concept of a screen displayed on a display unit of the information processing apparatus;

FIG. 13 is a view illustrating a specific example of a GUI as the save screen displayed on the display unit at the time of execution of a file saving software program by the information processing apparatus;

FIG. 14 is a view illustrating a specific example of the GUI as the seek screen displayed on the display unit at the time of execution of a file browser software program by the information processing apparatus; and

FIG. 15 is a view illustrating a specific example of the GUI as an email screen displayed on the display unit at the time of execution of an email software program by the information processing apparatus.

### BEST MODE FOR CARRYING OUT THE INVENTION

Hereinafter, a specified embodiment to which the present invention is applied is described in detail with reference to the drawings.

The embodiments are about an information processing apparatus such as a personal computer and the like. To manage files saved to a predetermined saving means such as a hard disk or the like, for example, the information processing apparatus manages a file using a concept of a condition set to seek and display the files by shaking off a conventional concept such that the file is saved to a saving area in a folder (directory) forming a hierarchical structure in a tree form.

Problems in file management using the conventional files based on a hierarchical structure in a tree form and a concept of such a file management system as newly proposed in the present invention are explained prior to a detailed explanation of the information processing apparatus to facilitate understanding of the invention.

The conventional folder is roughly equivalent to a bag for containing material goods, in which an entrance but not an exit is formed. Therefore, the goods contained in the bag basically remain inside and do not disappear automatically unless the contents are intentionally deleted. The bag, however, has a limit to its capacity, and increase in the goods makes it difficult to find an objective, which indicates a limit to a seeking skill of a human being. In a like manner, increase in contents of the folder makes it difficult to find a target file, which indicates a limit to a seeking property of the information processing apparatus.

In spite of variations among individuals, it is normal in modern society flooded with information that the amount of incoming information on the basis of email transmission/reception only reaches fifty a day, which is converted into twelve thousand on a yearly basis. Other than that, the amount of incoming information becomes extremely large in view of files produced by word-processing software in daily activities, files imaged by means of digital cameras, and the like. Correspondingly, a folder containing each of the folders can deal with thousands or tens of thousands of files in association with increase in the amount of hard disks and in performance of the CPU (Central Processing Unit). With human capacity, however, it depends on how to classify or name the files but it is difficult to seek the target file quickly from among the thousands or tens of thousands of files. Therefore, it is originally desirable to save into a single folder around twenty to thirty files, a list of which is displayable on a screen. However, it is not realistic to classify thousands or tens of thousands of incoming files into around twenty to thirty files in a single folder. Correspondingly, reducing the number of folders for the sake of reducing the classification work leads to decrease in working efficiency by lengthening a seeking time period. As described above, the reason why the files are required to increase to get reorganized even after being saved to the folder and well organized in a tree form is that there is a significant difference between the amount of incoming information and a stock (saving) management capacity of the folder.

Herein, as shown in FIG. 1, it is considered to switch a file management from a stock management having no exit for information I to a flow (flowing) management that discards the information I in an amount equal to the increase of information. Under the flow management, the information is managed on a flow basis, thereby not requiring to periodical organization. However, it is not easy to select the information to be discarded. This is because the file regarded as unnecessary is sometimes needed at a later date or because a judgment about the necessity of the file cannot be made at the time of creating or receiving the file, in many cases. Furthermore, the reason why it is not easy to select the information to be discarded is that the contents of the file need to be judged to discard the file, thereby taking time and effort.

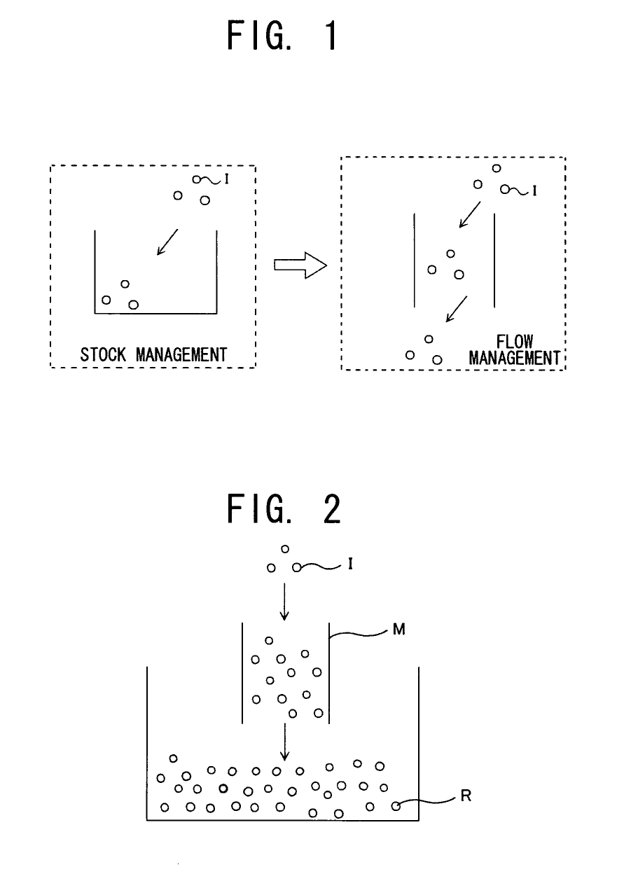

To automate the aforementioned selection of the information to be discarded, the meaning of “discarding” is viewed. As described above, it gradually becomes unnecessary to discard the information physically, that is, delete the information, because of the increase in capacity of the hard disk. The human capacity, however, has a limitation, thereby requiring temporal exclusion of the information from the managed objectives. That is, as shown in FIG. 2, the information I is not physically “discarded” but only excluded from managed objectives M, as shown in FIG. 2, thereby being saved as objective R which can be arbitrarily sought, so that the information as the objective R can be brought in substantially the same state as that of the “discarded” information.

Herein, a method of discarding the information automatically is viewed. Time is generally cited as the information as a criterion of judgment at the time of organizing physical documents or the like. That is, in many cases, old documents are generally unnecessary compared with new documents. In a like manner, the degree of freshness is important for the information as well and the value of the information declines over time. The time-based criterion to judge the information as unnecessary, however, depends on the information to be dealt with or dealing people, thereby rendering it unclear when the information becomes unnecessary. Furthermore, the information necessary regardless of a time elapse also exists.

In this regard, to set such the time to a criterion of judgment, the applicant of this application contemplated making it possible to easily specify the information by time. i.e., time information, at every time of saving the files so as to prevent display of needless files at the time of displaying the files, by displaying only the files corresponding to the specified time. With respect to the files that are important regardless of time, the applicant also contemplated managing only those files. It is to be noted that the time mentioned above is referred to as “management time” hereinafter.

Herein, the file contains a plurality of pieces of time information such as an update time, a creation time, and the like. According to this invention, the update time is basically used as the management time. According to this invention, the file is overwritten and saved to update the management time whereas the update time is set to a future date such as Dec. 31, 9999 or the like to display the management time at all times. According to this invention, execution of only the aforementioned processes can result in substantially the same effect as that of the case where the old information is automatically organized.

In the meantime, the reason why such a system crystallizing the aforementioned concept does not exist is that such a system is not suitable for the file management using as a saving area the folders forming a hierarchical structure in a tree form. Logically, under the file management system thusly structured, the files are arranged in accordance with the path information and saved. Therefore, in the case of seeking the file under the management system thus structured as using the management time, a target file is extracted by seeking the folders sequentially in the order from a folder corresponding to the root directory. This is because those files cannot be speedily sought nor displayed unless those are logically arranged in the order of hierarchical structure in a tree form, for convenience of the management such that the saving area for the files are managed based on the tree structure.

According to this invention, such the conventional concept is wiped off, that the saving area for the files is managed based on the tree structure, and the files are managed using a concept of a condition set in order to realize such a system as unifying the management by means of a flow. The file management system as proposed in the present invention will be described hereinafter.

The file management system proposed in this invention can seek the corresponding file from among various conditions by managing conditions included in or assigned to the files in a manner similar to a database.

Herein, the condition included in the file itself is so-called property information. The property information is composed of five pieces of basic information such as a file name, a saving area, a file type, a file size, and an update time or a creation time, and every file has those pieces of basic information. The target file, however, cannot be easily found even where those pieces of basic information are put in a database as conditions, unless the basic information can reflect the condition that the user desires to assign arbitrarily.

According to this invention, therefore, the path information of the file is used to render the basic information to be reflective of the conditions that the user desires to assign arbitrarily.

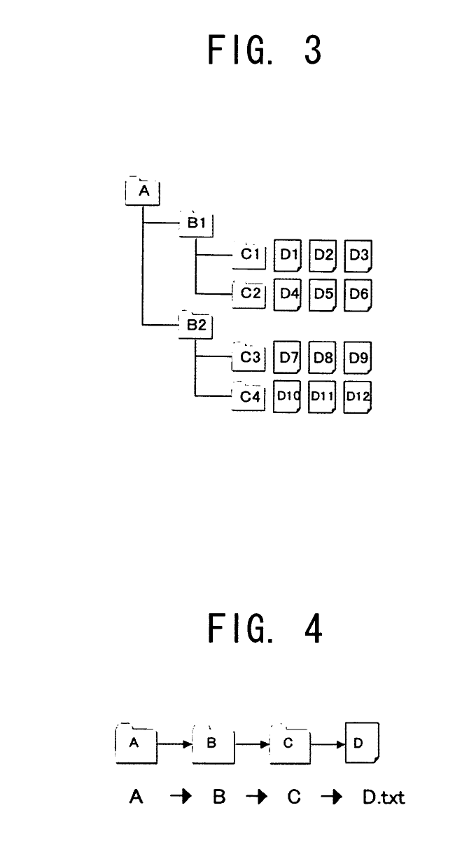

Locations of all of the files and folders are specified by the path information. This is because the file cannot be executed unless the saving area for the file is specified. Under the conventional file management system, as shown in FIG. 3, for example, the file is saved to the folder forming a hierarchical structure in a tree form formed in accordance with the path information, in which the saving area saving the file is managed.

Herein, in the hierarchical structure in a tree form, it is to be noted that a midway condition (folder) is defined as an essential selection condition that does not allow a selection sequence to be changed. That is, under the conventional file management system based on the hierarchical structure in a tree form, as shown in FIG. 4, for example, on the condition that such the hierarchical structure as composed of folder “A”\ folder “B”\ folder “C”\ text file “D” is formed, the sequence of selecting the folder cannot be changed to reach the target text file “D” in a manner to omit selection of the folders “A”, “B” existing midway between a folder corresponding to a root directory and the folder “C” saving the text file “D” or to select the folder “C” first and then the folder “B” at a higher level in the hierarchy.

In the meantime, there is an exception such as a shortcut to the file management system based on the hierarchical structure in a tree form incapable of changing the selection sequence. The shortcut is to reach the target file by skipping the midway folders as the essential selection conditions to reach the target file. For example, in the case of using a shortcut to the folder “B” as shown in FIG. 4, selection of the folder “A” as a condition to reach the text file “D” can be omitted. Therefore, the sequence of selecting the folders at a lower level than the folder “B” in the hierarchy cannot be changed but selection of one essential selection condition can be omitted.

Correspondingly, it is contemplated to omit selection of the folders at a lower level than the specific folder in the hierarchy. Noted herein is stationery such as a so-called clear folder. The clear folder enables the file contents inside the folder to be browsed without requiring the folder to be opened. This invention adopts a concept of the clear folder, thereby enabling file seeking as described hereinafter, which is conventionally not performable.

In using a conventional software program as a file browser such as so-called Explorer, unless the folder saving the target file is selected, the target file is hidden behind the folder, thereby not being able to be displayed. In the example shown in FIG. 4, for example, the text file “D” cannot be browsed unless the folder “C” is selected. Therefore, in the case where two or more folders exist at a lower level than the folder “B” in the hierarchy and the user or the like forgets in which folder the target file is saved, those folders in which the target file could be saved need to be confirmed individually.

Therefore, this invention provides a GUI (Graphical User Interface) as a function capable of browsing the file contents in the folder without requiring the folder to be open like the clear folder so that the folders at a lower level of the arbitrary file in the hierarchy are not displayed but only files inside those non-displayed folders are displayed. For example, in the example previously shown in FIG. 3, six files “D1” “D2”, “D3”, “D4”, “D5”, and “D6” saved to folders “C1” and “C2” at a lower level than folder “B1” can be displayed without displaying the “C1” and “C2” by using the clear-file function at that stage of selecting the folder “B1”. As described above, in this invention, by using the clear-file function, a condition can be sought from a wide range without confirming the plurality of folders individually even though the number of displayed files increases.

Furthermore, it is considered to omit the folders existing midway and to change arbitrarily the sequence of selecting the folders. The applicant of this application found out that the folders existing midway can be set to an arbitrary selection condition, which allows a selection sequence to be changed without processing the conventional path information.

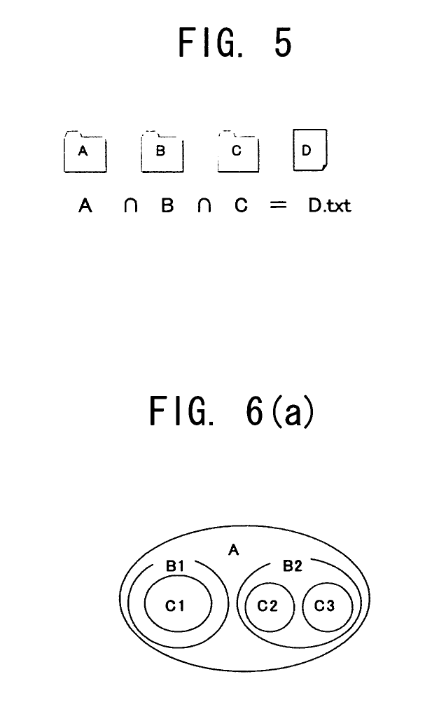

That is, the path information is recognized as a condition set in this invention. To be more specific, in the case of the hierarchical structure composed of folder “A”\ folder “B”\ folder “C”\ text file “D”, for example, the path information is read as information indicating a condition set, thereby being recognized as “the “text file “D” satisfying condition “A”, condition “B”, and condition “C” (A∩B∩C=D.txt)” as shown in FIG. 5, unlike the conventional file management system in which the path information is recognized as “the text file “D” in the folder “C” in the folder “B” in the folder “A” (A→B→C→D.txt)” as shown in FIG. 4. In other words, according to this invention, the path information is recognized as a condition set in which the selection sequence is changeable and each condition is an arbitrary selection condition, not as a saving area in which the selection sequence is unchangeable and each condition is defined as an essential selection condition.

As described above, the path information is recognized as a condition set, so that an element \ . . . \ composing the path delimited by a delimiter \ does not have the information indicating the saving area such as a folder. Thus, according to this invention, a keyword or the like as a seek condition can be registered as the path information.

In this invention in which the path information is recognized as a condition set, it is to be noted that the conventional file can be used directly in accordance with a new recognition method, without adding any new items to the property information included in the existing file nor interfering with specification of a saving area for the file. Thus, all of the files can be directly recognized as a condition set in this invention.

Herein, a condition set is viewed.

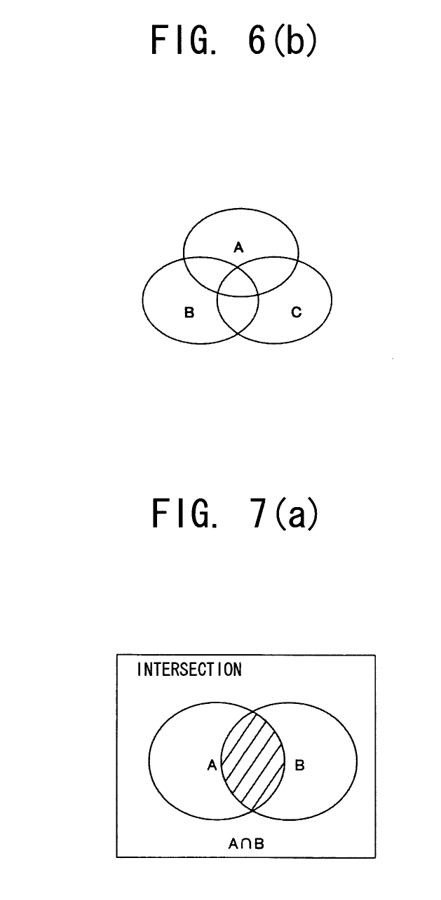

Each folder can be regarded as one type of condition sets as well under the conventional file management system based on the hierarchical structure in a tree form. For example, under the file management system, in the case where there exist two folders, “B1” and “B2”, as sub-folders of the folder “A”, there exists folder “C1” as a sub-folder of the “B1” and there exist two folders, “C2” and “C3”, as sub-folders of the folder “B2”, those folders can be figured by a Venn diagram as shown in FIG. 6 (a) on the condition that each folder is regarded as a condition set. Under the file management system as described above, however, jumping from the folder “A” as an outermost condition set to the folders “B1” and “B2”, and the folders “C1”, “C2”, and “C3” as an inner condition set contained in the folder “A” is set to an essential selection condition, while overlap among the condition sets is not permitted and furthermore, the target file cannot be displayed unless the folder saving this target file is selected.

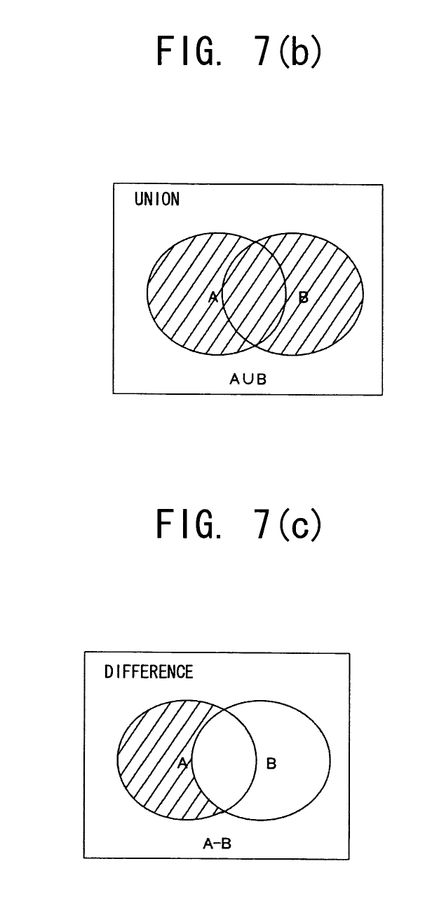

On the other hand, under the file management system recognizing the path information as a condition set, in the case where there exist three conditions “A”, “B”, and “C”, for example, those folders can be expressed by a Venn diagram as shown in FIG. 6 (b), allowing overlap among the condition sets on the condition that each folder is regarded as a condition set, and each folder can be set to such an arbitrary selection condition in the condition set, allowing the selection sequence to be changeable. Furthermore, by adopting a concept of a condition set, the aforementioned file management system can seek the file based on concepts such as, e.g., product of sets (intersection) as shown in FIG. 7 (a), union of sets as shown in FIG. 7 (b), and difference of sets as shown in FIG. 7 (C).

In summary, the merits brought by application of the condition set are as follows.

The first merit is that the sequence of selecting the conditions is changeable. The sequence of selecting the conditions can be changed by recognizing the path information as a condition set. Under the conventional file management system, according to the nature of the hierarchical structure in a tree form, there has been no choice but to manage the files by assigning the sequence even to such folder classification in which the sequence is originally not decided. On the other hand, the file management system applying the concept of a condition set can seek the target file by narrowing the condition in an arbitrary sequence, thereby being able to seek the file based on a condition corresponding to needs at different times.

The second merit is that the conditions can be arbitrarily selected. Under the conventional file management system, the folder in the path is an essential selection condition, and the target folder cannot be specified in the case where even a single item existing midway is forgotten, even where the other items are remembered. Therefore, under the conventional file system, by increasing the number of folders indiscriminately, the number of candidate folders having the possibility of saving the target folder or the number of folders to be selected by the time of specifying the target file is increased, so that increase in the number of folders results in hindrance to the file seeking operation. Under the conventional management file, furthermore, in the case where the number of files saved to the single folder is increased instead of increasing the number of folders to avoid the aforementioned situation, the distinction between the files tends to be inadequate, thereby requiring a lot of time to find the target file. On the other hand, the file management system adopting a concept of a condition set, the path information is recognized as a condition set, thereby being able to arbitrarily make a determination as to whether the condition is used at the time of seeking, so that segmentalization of the condition does not result in hindrance to the file seeking operation. Thus, under this file management system, a condition which could not be assigned conventionally can be assigned, thereby being able to seek the file from the various viewpoints, remarkably improving seek accuracy and speed.

Furthermore, the third merit is that the file can be saved to the plurality of conditions. Under the conventional file management system, the single file cannot be saved to the plurality of folders at the same time. Under the conventional file management system, therefore, where the file needs to be saved to the plurality of areas requiring branching of the path, it is necessary to save the file to any one of the folders or to save the plurality of files as different types in the plurality of folders, separately. Under the conventional file management system, in the former case, it is necessary to detect the target file from among the plurality of folders in which the file can be saved, whereas in the later case, since the files have nothing in common, all of the files need to be updated individually in the case of updating the file information. On the other hand, under the file management system adopting a concept of a condition set, substantially the same effect can be easily obtained as that of the case where the same files are saved to the plurality of folders at the same time, and further updating of the information can be reflected even in the case of performing the seeking operation based on all of the conditions since there is a single original file.

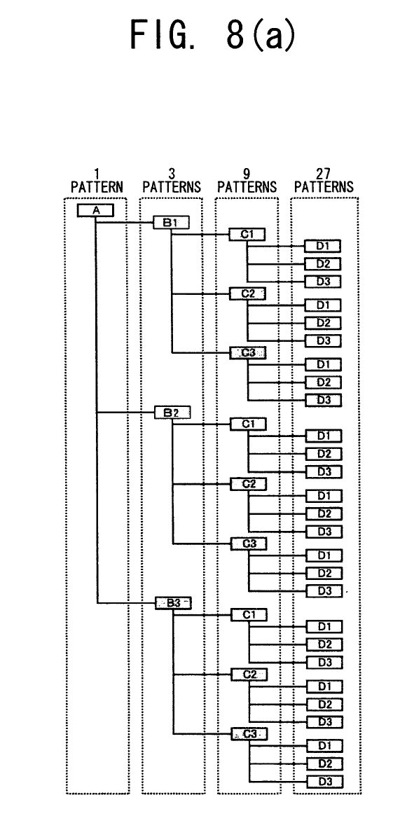

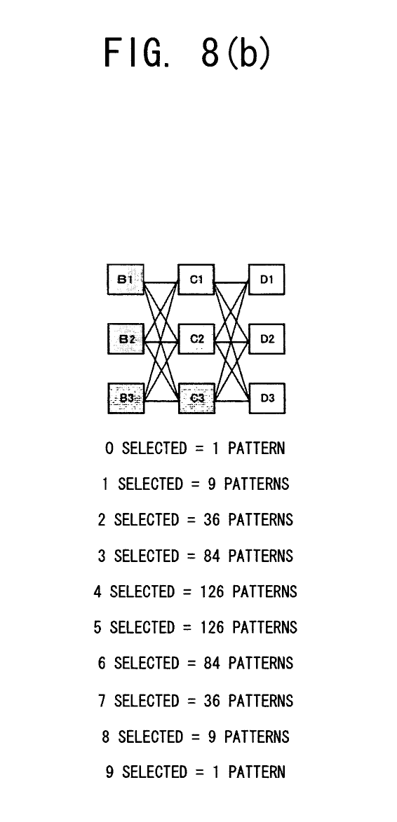

Yet further, the fourth merit is that the number of necessary conditions is remarkably reduced in the case where the same classification is made to the folders (conditions). Where each of three elements is classified into three types, for example, the folder sequence cannot be changed under the conventional file management system, thereby requiring classification into 3×3×3=27 folders, as shown in FIG. 8 (a). On the other hand, the file management system adopting a concept of a condition set enables substantially the same classification with 3+3+3=9 conditions, as shown in FIG. 8 (B). Additionally, since the midway folder can save the file under the conventional file management system, so that there are 1+3+9+27=40 patterns of saving area whereas there are logically 1+9+36+84+126+126+84+36+9+1=512 patterns of saving method under the file management system adopting a concept of a condition.

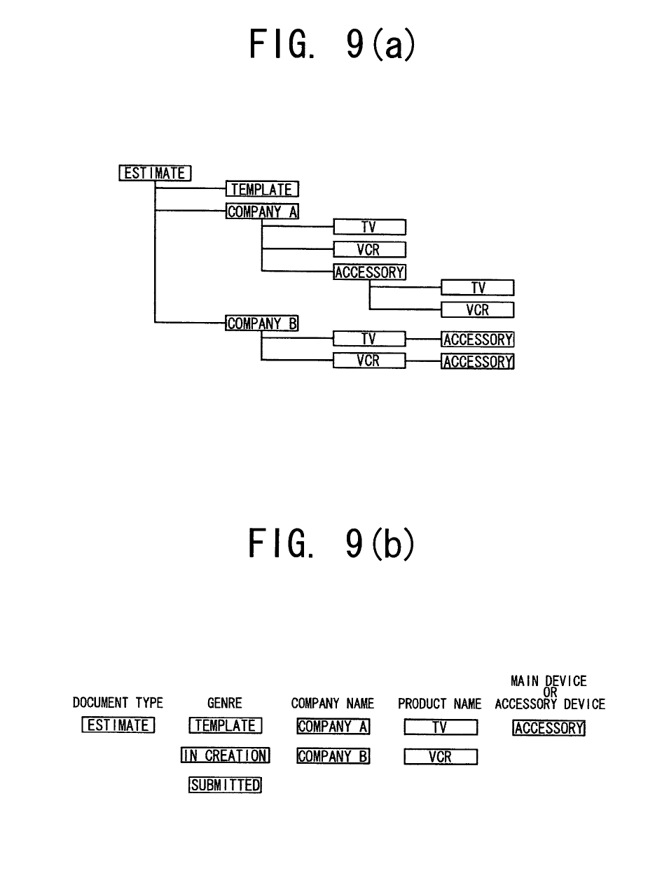

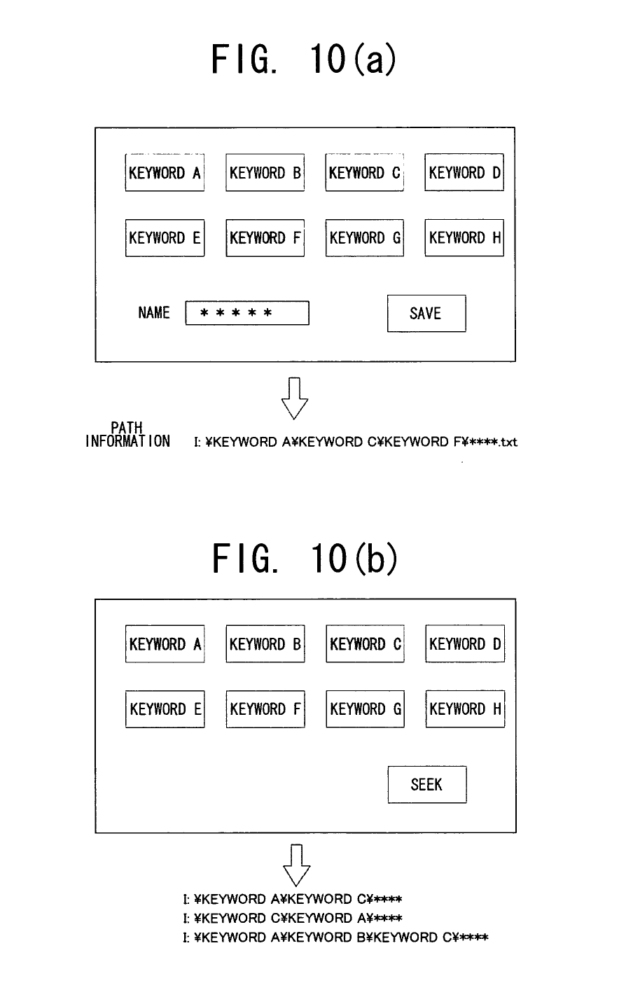

The fifth merit is that the management can be performed such that, in a condition that the folders can be freely placed, the folders are not managed based on a hierarchical structure in a forced manner. Under the conventional file management system, a case is frequently causedwhere such folders exist at the same level in the hierarchy, as classified based on different criteria since the folders are managed only based on a depth from the root folder in the hierarchy, thereby leading to a contradiction or an overlap at the time of determination of the saving area for the file. Under the conventional file management system, furthermore, the classification sequence strongly reflects a personal point of view of a creator of a tree, i.e., a person who saved the file, and further, it is impossible to display the criteria of classifying the folders in accordance with the tree, so that a third party other than the person who saved the file has difficulty in seeking the specific file. To be more specific, as shown in FIG. 9 (a), the folder “template” classified as a folder expressing genres of files, and the folders “company A” and “company B” classified according to customer's names are not supposed to be placed in the same level in a hierarchy since these folders are classified based on different criteria. Furthermore, it depends on a personal point of view of a person who classifies the folders whether the folder “accessory” for saving files concerning accessories is dealt at the same or a lower level compared with the folders “TV” and “VCR” for saving the files regarding main devices that are not accessories.

On the other hand, under the file management system adopting a concept of a condition set, the folders are freely placed, and further the criteria for folder classification of the files can be displayed and the files can be managed with the criteria as new conditions, thereby hardly causing such a contradiction or the overlap as caused under the conventional file management system. The conventional file management system, furthermore, manages the files in a saving area of a folder forming the hierarchical structure in a tree form, thereby basically resulting in one pattern of method of displaying the files, whereas the file management system adopting a concept of a condition set enables free design or change of a condition display area, such as non-display of the midway condition or change of the placement sequence, which was conventionally impractical. Thus, under the file management system adopting a concept of a condition set, the user can seek the file by using an interface that he designed for himself. To be more specific, in the case of classification based on the condition set as shown in FIG. 9 (a), a hierarchy can be freely changed based on classification criteria as shown in FIG. 9 (b), thereby being able to display the classification criteria. Furthermore, the file management system adopting a concept of a condition set requires only classification and the classification sequence becomes irrelevant, so that a personal point of view of the person who classifies the folders is hardly reflected. Additionally, under the file management system adopting a concept of a condition set, the condition is arbitrarily selected, allows the selection sequence to be freely decided, and is selected based on not a saving area but a combination, so that the number of conditions can be reduced compared with the conventional file management system.

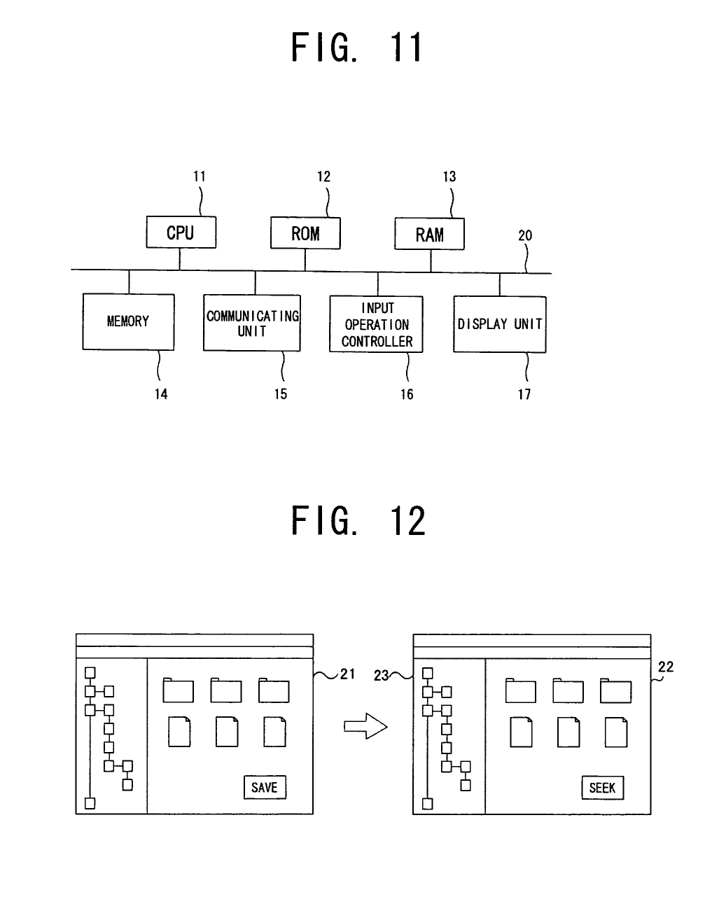

Under the file management system adopting a concept of a condition set, the user decides on keywords to be registered as a condition and assigns the desired keywords through a save screen having buttons or the like arranged therein, for specifying keywords as shown in FIG. 10 (a), at the time of saving the file, so that the information having the keywords registered therein as the path information is created as the information for specifying the file. Described herein is a state where three keywords A, C, and F are specified. At this time, the aforementioned management time may be registered as one part of the path information under the file management system. On the other hand, at the time of seeking the file under this file management system, the user seeks the file by specifying the desired keywords, time, and the like through a seek screen having buttons or the like arranged thereto, for specifying the keywords as shown in FIG. 10 (b). Under the file management system, conditions are arbitrarily assigned, and only the file name is necessarily assigned. In this case, the file can be sought based on the management time, the file type, and the file name.

An information processing apparatus to which the file management system adopting a concept of the aforementioned condition set is concretely applied is described hereinafter.

The information processing apparatus enables seeking of the file by executing a condition seek based on a condition set. Herein, the difference between the “condition seek” and the “seek” is contemplated.

First, in the existing “seek” operation, a determination is made as to whether the file name or the property information contains the specified word, and the objective containing the word is displayed as a result. That is, the existing “seek” operation does not manage word registry itself in the objective file but adopts a method of seeking unilaterally for the objective file, by which the file is sought based on such a “character string” contained therein as desired to be sought, not on the “seek word (keyword)”, thereby undesirably picking up even the unnecessary information. The conventional system performing the existing “seek”, therefore, cannot obtain accuracy necessary for the file management, and usually seeks the desired file by using the folders in a tree form while using the “seek” operation only where the file cannot be found.

On the other hand, since the “condition seek” operation manages the files based on “the seek word” as a condition, not just on “the character string” from the time of registry, the candidate information is previously decided, so that the information not corresponding to the condition is not picked up, thereby resulting in perfect accuracy necessary for the file management. For example, at the time of registering the seek word with the information processing apparatus as described below, unusable forbidden characters such as “\” and the like are previously defined to clarify a range of the keywords by sandwiching the seek word between the forbidden characters, i.e., “\keyword\”, for example. Thus, the information processing apparatus can make the seek results for other keywords which contain the keyword as a character string not be displayed by performing the condition seek for each of the forbidden characters. Specifically, in the case of setting the keyword “ABC” to the seek word in the information processing apparatus, where a wild card is set to “*”, a range of “*\ABC\*” is handled as a single condition, so that even where another keyword including “ABC”, such as the keyword “EFABC” exists, the seek result for this keyword is displayed. As described above, the “condition seek” operation can eliminate noise in the seek result, whereas inversely, enabling such use that the seek result containing the keyword is eliminated at practical levels.

Moreover, in the existing “seek” operation, it is necessary to assume the appropriate word to be selected, and the target file cannot be detected where the file does not correspond to the word. On the other hand, in the “condition seek” operation, since the candidates are previously displayed, the above word is selected from among these files. Furthermore, the existing “seek” operation requires time to check all of the conditions, whereas the “condition seek” operation is performed based on only the already-determined conditions, thereby being able to be terminated in a shorter time than the existing “seek” operation.

As described above, the “seek” and the “condition seek” are regarded as different concepts.

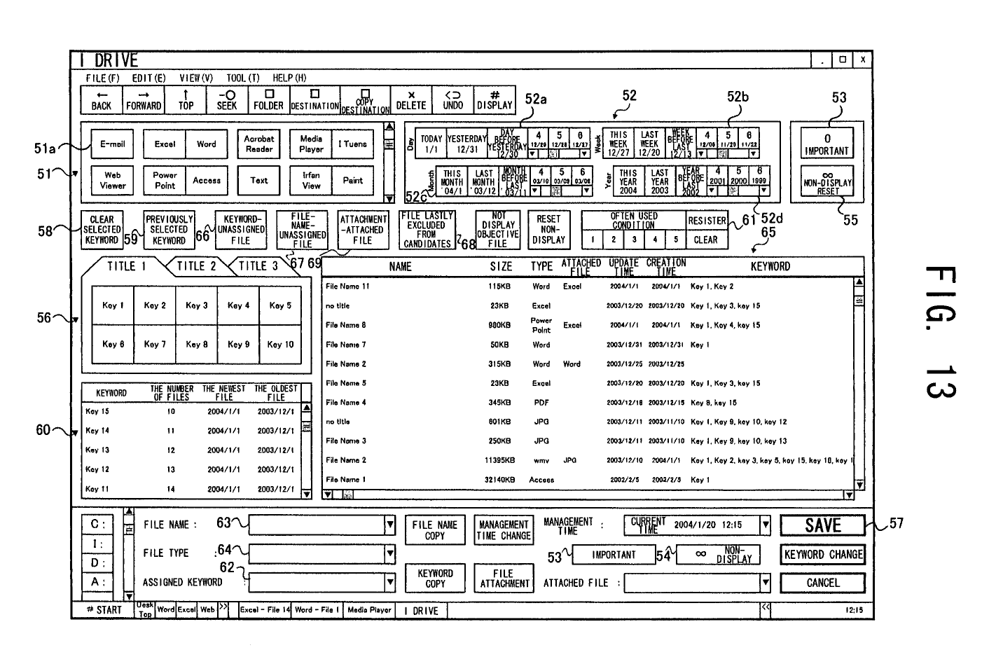

The information processing apparatus performs the “condition seek” operation having characteristics superior to the existing “seek” operation. To be more specific, the information processing apparatus includes, as shown in FIG. 11, a CPU 11 for totally controlling each unit, a ROM (Read Only Memory) 12 for reading and storing various kinds of information, a RAM (Random Access Memory) 13 functioning as a work area, a memory 14 for storing in a reading-out and/or writing-in manner various kinds of information such as software programs for realizing the file management system adopting a concept of a condition set, or the files, a communication unit 15 for conducting communication by connecting to external networks, an input operation controller 16 for processing and controlling the input operation made through a predetermined operation device, not shown, and a display unit 17 for displaying various kinds of information, and those units are each connected to a bus 20.

The CPU 11 completely controls each unit upon execution of each of various software programs recorded in the ROM 12.

The ROM 12 stores various kinds of information such as various programs. The information stored in the ROM 12 is read out under control of the CPU 11.

The RAM 13 functions as a work area at the time of execution of the software program by the CPU 11, temporally stores various kinds of information under control of the CPU 11, and reads out various kinds of stored information.

The memory 14 stores under control of the CPU 11, various kinds of information such as, e.g., software programs for realizing the file management system adopting a concept of a condition set, various files, and the like while reading out various kinds of stored information. As the memory 14, for example, a hard disk, a nonvolatile memory, or the like can be used. The memory 14 includes a drive device for reading out and/or writing in various kinds of information with respect to a memory media such as a flexible disk, a memory card, and the like, which are detachably attachable to the main device.

The communication unit 15 is an interface for connecting to an analogue line, a LAN (Local Area Network) composed of a so-called Ethernet®, and the like, various network lines such as an ISDN (Integrated Services Digital Network), an ADSL (Asymmetric Digital Subscriber Line), or an FTTH (Fiber To The Home), various wireless communication systems such as a wireless LAN based on IEEE (Institute of Electrical and Electronic Engineers) 802.11 or a so-called Bluetooth®, or a network based on various systems such as a W-CDMA (Wideband-Code Division Multiple Access) system such as a FOMA® or a CDMA-2000 system such as an HDR (High Date Rate). The communication unit 15 conducts communication to an external unit, under control of the CPU11.

The input operation controller 16 accepts the input operation through predetermined operation devices, not shown, such as a keyboard, a mouse, a keypad, an infrared remote controller, stick keys, push buttons, and the like, and supplies the CPU 11 with a control signal indicating operation contents.

The display unit 17 is defined as various display devices such as a Liquid Crystal Display (LCD), a Plasma Display Panel (PDP), an Organic ElectroLuminescent) display, a Cathode Ray Tube, and the like, and displays various image files, other kinds of information, and the like, under control of the CPU 11. For example, the display unit 17 displays on the display screen the save screen for saving the file, the seek screen for seeking and displaying the saved file, the GUI at the time of execution of the various application software programs.

The information processing apparatus having those units can execute with the CPU 11, various application software programs that can realize the convenience caused by the file management system adopting a concept of a condition set.

It goes without saying that the information processing apparatus can manage the file by using only the file management system adopting a concept of a condition set but assumed herein is coexistence of this file management system and the existing file management system which uses the folders forming a hierarchical structure in a tree form.

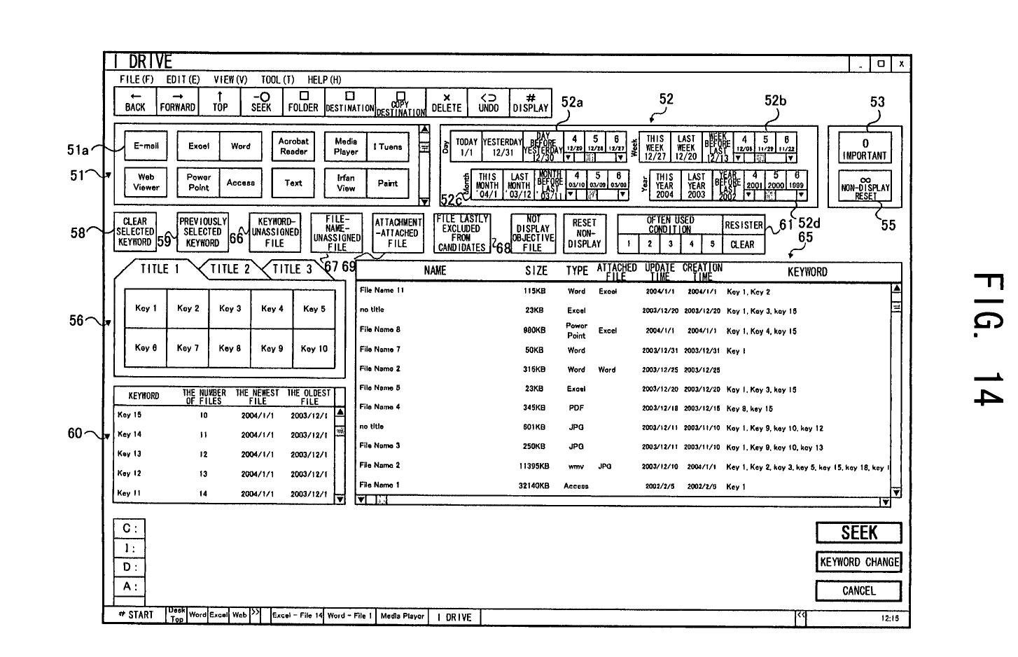

That is, in the information processing apparatus, by creating a partition, the memory 14 is divided into a drive adopting the existing file management system and a drive for saving and seeking the files based on the file management system adopting a concept of a condition set. Herein, the latter driver is referred to as an I (Information) drive. Thus, the information processing apparatus can benefit from this invention while storing system files or the like in the drive adopting the existing file management system, such as C drive or the like. In the case of selecting the I drive through a file browsing screen 21 such as the existing Explorer as shown in a left side of FIG. 12, the information processing apparatus displays the seek screen 22 as previously shown in FIG. 10 (b) on the display unit 17, as shown in a right side of FIG. 12. At this time, the information processing apparatus displays on the display unit 17 a screen 23 for displaying a tree view of the drives together with the seek display 22, thereby being able to swap the files between the I drive and the other drives. Herein, in the case of moving the file stored in the I drive to another drive, the information processing apparatus can move or copy the file which was sought and displayed through the seek screen 22, by dragging and dropping an icon indicating the desired drive using the mouse or the like. On the other hand, in the case of moving the file stored in another drive to the I drive or saving the created file, the information processing apparatus displays on the display unit 17 the save screen such as previously shown in FIG. 10 (a), instead of the seek screen 22, thereby being able to save the file upon assignment of the keywords or the like as a condition.

A specific example of the save screen for saving the file and the seek screen for seeking and displaying the saved file will be explained hereinafter.

The save screen is explained first.

Where the target file cannot be found, most users using the information processing apparatus adopting the existing file management system are forced to an operation to confirm the folders individually, thinking about “which folder is the file saved to?”. The applicant of this application, however, thinks that in the aforementioned case, the file should be sought based on the properties of the file such as “when and by what software the file is created” and “what the file name is.” To crystallize this thought, the information processing apparatus executes the predetermined software program for saving the file by the CPU 11, thereby displaying on the display unit 17 the GUI as the save screen, such as shown in FIG. 13. That is, the information processing apparatus displays on the display unit 17 the GUI that visualizes functions for specifying various conditions.

To be more specific, the save screen is provided with program buttons 51 corresponding to various application programs stored in the information processing apparatus so as to select a type of file as a condition. The program buttons 51 are composed of a plurality of buttons that are formed corresponding to word processing software such as Word and spreadsheet software such as Excel provided by Microsoft® Corporation. The program buttons 51 are formed mainly to narrow down the seek objectives based on a file type and to activate the program itself.

To be more specific, by a single-click using the mouse or the like in the information processing apparatus, each of program buttons 51 is selectable and such an extension is specified, as registered at a rightmost end of the path information of the file to be saved. Furthermore, the information processing apparatus cancels selection by another single-click of the selected program button 51. At this time, in the information processing apparatus, only the program button 51 that is single-clicked last is basically regarded as a selected button, and a single-click of another program button cancels selection of the previously selected program button. Furthermore, in the information processing apparatus, each program button 51 is provided with a launcher function to activate the corresponding application program according to a double-click of the button. Thus, the information processing apparatus can start creation of the new file through the program buttons 51. In the meantime, with respect to an email button 51a, an email application program is activated according to a single-click to display an email screen to be described later on the display unit 17. Furthermore, with the information processing apparatus, the extensions that the user seeks for each of the program buttons 51 can be customized. It is to be noted that the aforementioned program buttons 51 may be registered automaticallywith respect to all application programs executable by the information processing apparatus or may be arbitrarily registered by the user in a manner similar to a shortcut-creating operation.

Furthermore, the save screen is provided with time-period specifying buttons for narrowing down the files as the seek objective based on a time period by selecting a time condition of the file. The time-period specifying button 52 is composed of a daily-basis time-period specifying button 52a for specifying the management time based on a day, such as “today”, “yesterday”, “the day before yesterday”, and the like, a weekly-basis time-period specifying button 52b for specifying a range of the management time based on a week, such as “this week”, “last week” “the week before last”, and the like, a monthly-basis time-period specifying button 52c for specifying a range of the management time based on a month, such as “this month”, “last month”, “the month before last”, and the like, and a yearly-basis time-period specifying button 52d for specifying a range of the management time based on a year, such as “this year”, “last year”, “the year before last”, and the like, which are all formed in parallel. A time division can be arbitrarily set without being limited to the manner shown in FIG. 13, but is desirable to be made not only with units of days but also with units of weeks, months, and years, such as “a week” or “a month” in FIG. 13. This is because, in real life, the date “seven days ago” is remembered more as “last week” and the date “thirty-five days ago” is remembered as “last month”

With the information processing apparatus, the time-period specifying button 52 can be selected by a single-click, and the aforementioned management time is registered in the path information of the file to be saved, i.e., “\2004/1/1\˜”. With the information processing apparatus, the selected time-period specifying button 52 is single-clicked once again to cancel the selection thereof. At this time, in the information processing apparatus, only the time-period specifying button 52 that is single-clicked last is basically regarded as a selected button, and a single-click of another time-specifying button cancels selection of the previously selected time-specifying button. Furthermore, with the information processing apparatus, the plurality of time-period specifying buttons 52 formed in a parallel manner are dragged to specify the desired time period easily and speedily, thereby being able to select a range by being dragged in this manner. Furthermore, with the information processing apparatus, the predetermined key such as a shift key is pushed while two arbitrary time-period specifying buttons 52 are single-clicked, so that a range of two time periods that were selected in this manner can be selected. Yet further, with the information processing apparatus, the predetermined key such as a control key is pushed while the plurality of time-period specifying buttons 52 are single-clicked, so that the plurality of time periods can be selected even where those periods are not consecutive. Furthermore, with the information processing apparatus, the predetermined key such as an Alt key is pushed while one or more arbitrary time-period specifying buttons 52 are single-clicked, so that the selection can be made in a manner not to include the selected time period as the management time, for example, to omit only today from this week.

Herein, as described above, with the information processing apparatus, the management time is basically set to the same date as the update time, but can be changeable freely for convenience of management. For example, where the management time of another file that belongs to the same group is one year earlier compared with the file, it is presumed that those files are difficult to be handled together in this state, so that the information processing apparatus can set the management time of the file to the same as (or close to) that of the other file by hand. Furthermore, the information processing apparatus can use the creation time of the file as the management time or can re-register the present time as the management time.

The information processing apparatus can manage the keywords as a condition to be registered in the path information, but the management time of this keyword is set to the most recent time among times in the file having the keyword whereas the creation time of this keyword is set to the oldest time among times in the file having the keyword. Those times are referenced at the time of saving the file or changing the keyword and are changed if needed. Therefore, the information processing apparatus can always manage a time period range of the file having the keyword and only the files of an objective time period are required to be changed at the time of changing or deleting the file name.

Furthermore, the save screen is provided with a time-period specification deselection button 53 as a special button utilizing the management time. The time-period specification deselection button 53 is formed to classify the important files as having importance that is unchangeable over time so as to save and seek those files. Specifically, the information processing apparatus displays as the seek results, all of the files that were registered in accordance with selection of the time-period specification deselection button 53, regardless of the aforementioned time-period specifying button and the management time, in the seeking operation. Therefore, it is convenient to previously register in the information processing apparatus by means of the time-period specification deselection button 53, the highly important files which are rarely updated, such as an address book, a fee schedule, an operation guide, a template, and the like.

To be more specific, in the information processing apparatus, the time-period specification deselection button 53 can be selected by a single-click, and “A” is assigned at the front of the management time in the path information of the file to be saved, for example, “I:\A2004/1/1\˜”. This assignment has a meaning roughly equal to setting the update time to a future time such as Dec. 31, 9999. Therefore, the information processing apparatus sets the management times of the files to a future time compared with the files having the normal management time, thereby being able to select and display the files having the future management times by separating those files from the files having the normal management time. The information processing apparatus manages fixed keywords to be described later by assigning “A” at the front of the management time in a similar manner. Furthermore, the information processing apparatus cancels selection by another single-click of the previously selected time-period specify deselection button 53. Yet further, the information processing apparatus fixes selection by a double-click of the time-period specify deselection button 53, while canceling selection by another single-click thereof.

The save screen is provided with a non-display button 54 and a non-display reset button 55 as a special button that utilizes the management time. The non-display button 54 is formed to register the files, display of which is considered as unnecessary in the seeking operation, thereby enabling exclusion of the files from the candidate files to be sought. On the other hand, the non-display reset button 55 is used to display again in the seeking operation the files that were registered once as a non-display file. A function by the non-display button 54 and non-display reset button 55 is different from the conventional trash box in that even the files defined as a non-display file can be managed and selectively displayed based on the keywords or the time period and that the files can be sought together with the normal files even where the user do not know whether the file was set to the non-display file.

To be more specific, in the information processing apparatus, the non-display button 54 and the non-display reset button 55 can be selected by a single-click. The information processing apparatus assigns the aforementioned forbidden character “\” after the management time in the path information of the file to be saved in the case of selection of the non-display button 54. Therefore, the information processing apparatus can prevent only the specific files from being displayed by extracting the files which have the path information containing “\ \” and by setting those extracted files to a non-display file. Furthermore, with the information processing apparatus, the prohibition process is set to a registration condition, thereby eliminating the possibility that the information indicating a non-display state as described above is confused with a keyword or a file name. At this time, the information processing apparatus does not change the management time, thereby being able to utilize the management information before selection of the non-display state, at the time of resetting the non-display state though the non-display reset button 55. Furthermore, in the information processing apparatus, the selected non-display button 54 and the non-display reset button 55 are single-clicked once more to cancel the selection thereof. Therefore, in the information processing apparatus, since the management time information remains without change, selection can be immediately made using the time-period specifying button by selecting the non-display reset button 55 with respect to the file registered as the non-display file. Furthermore, the information processing apparatus fixes selection of the non-display button 54 and the non-display reset button 55 by a double-click thereof while canceling the fixed selection thereof by another single-click thereof.

The save screen is provided with a keyword selection button 56. The keyword selection button 56 is formed to narrow down the files as a seek objective based on a keyword arbitrarily set by the user.

To be more specific, with information processing apparatus, the user arbitrarily registers a keyword in advance as the keyword selection button 56. In the information processing apparatus, at the time of saving the file, the user selects a keyword by single-clicking a button corresponding to the keyword that the user intends to register and saves the file in this state, thereby registering the keyword of the selected button in the path information of the file. Thus, with the information processing apparatus, the user selects the keyword selection button 56 at the time of seeking the file to seek the keyword registered by the button and to display the objectives, thereby being able to narrow down the files. In the information processing apparatus, to assign the keyword of the keyword selection button 56, having been selected at the time of pushing the saving button 57, to the path information, the selection order of buttons at the time of registration is arbitrary. In the information processing apparatus, the keywords may be sequentially assigned every time that the keyword selection button 56 is selected. In the information processing apparatus, furthermore, the selected keyword selection button 56 is single-clicked once again to cancel selection thereof. In the information processing apparatus, furthermore, the keyword selection button 56 is double-clicked to activate the predetermined screen for changing and saving a setting of the keyword. Accordingly, the information processing apparatus can set the arbitrary keyword. In the information processing apparatus, furthermore, a keyword clearance button 58 is single-clicked to bring all of the keyword selection buttons 56 to an unselected state. Furthermore, in the information processing apparatus, a previous keyword selection button 59 is single-clicked to bring the keyword selection button 56 that was selected at the time of previous saving operation to a selected state.

With respect to the keyword selection button 56, such a keyword as uninfluenced by time factors, such as a template, an estimate, and the like is normally registered. The keyword is referred to as a fixed keyword. On the other hand, in the information processing apparatus, the save screen is provided with a movable keyword selection area 60 for registering a movable keyword defined as a keyword influenced by time factors, such as a meeting preparation, complaint handling, and the like. This will be explained later. In the information processing apparatus, furthermore, a common keyword is assigned to a category such as a theme, a title, and the like, and the plurality of keyword selection buttons 56 can be grouped under categories switchable by a tab key, such as “company (outside company)”, “company (inside company)”, “individual”, “music” “photograph”, and the like, to facilitate seeking operation along with each purpose. At this time, in the information processing apparatus, the keyword selection button 56 is desirably changeable over different categories.

Herein, the information processing apparatus is required to manage the keyword to be assigned as a condition. The keyword is handled as a single file, such as “I:\November Business Trip to U.S.A. key\”. In the information processing apparatus, the keyword displayed on the save screen may be directly registered in the path information, and may be registered as a symbol string in the path information, for example, a keyword ABC may be registered as “A01”, in order to shorten a length of the path information.

The fixed keyword and the movable keyword described above are used as the keyword. The fixed keyword is always displayed as the keyword selection button 56 regardless of the objective time period in the seeking operation, by using the future date such as Dec. 31, 9999 as the management time of the keyword file. With respect to the movable keyword, on the other hand, the contents displayed on the movable keyword selection area 60 are changed according to selection of the time-period specifying button 52, by defining the desired display objective time as the management time of the keyword file. Meanwhile, the management time of the keyword is not the creation time but is automatically updated at the time of updating the file having the path information containing the keyword. Furthermore, in the information processing apparatus, in the case where the keyword is unnecessary but desired to remain only in the non-display state, the past date such as Jan. 1, 1900 is assigned as the management time of the keyword file, thereby being able to display only those keywords as a whole. It is to be noted that the normal file time-period specification and the keyword time-period specification are completely different but in the information processing apparatus, the management time of the keyword file may be set using the aforementioned time-period specifying button 52 or the time-period specification deselection button 53 to facilitate the operation.

Furthermore, in the information processing apparatus, the movable keyword can be managed using the fixed keyword. In the information processing apparatus, for example, the movable keywords such as “November Business Trip to U.S.A.” or “December Business Trip to England” can be managed by the fixed keyword such as “Business Trip”. In this case, the update time indicating the desired display objective time period to be displayed on the movable keyword selection area 60 is assigned as the management time to the keyword file of this movable keyword whereas the future date is assigned as a condition to the keyword file in a manner similar to the fixed keyword.

Other than the above, the save screen is provided with a condition selection shortcut 61 for selecting the specific conditions at once. The operation with use of the mouse is generally more burdensome than the operation with use of the keyboard in many cases. In the information processing apparatus, in the case where there exist many conditions to be selected or where the same conditions or the same condition combination are used with high frequency, those conditions are previously registered to be highly convenient. Herein, in the information processing apparatus, the specific condition can be registered by forming the condition selection shortcut 61 that is operated not only by selection using the mouse but also by input of a single letter using the keyboard, so that the keyword or the like as a condition can be easily assigned.

In the information processing apparatus, the assigned keyword is displayed on a keyword display area 62 by assigning through the aforementioned save screen the condition to the file to be saved. In the information processing apparatus, furthermore, the file name is input or selected through a file name input selection box 63 or a file type is input or selected through a file type input selection box 64 and the saving button 57 is pushed to save the file to the I drive, according to necessity. In the meantime, the keyword is not necessarily assigned as a condition and only the file type selected through the program button 51 or the time period selected through the time-period specifying button 52 is required to be assigned as a condition.

The detailed operation for saving the file through the save screen is described herein.

First, as an example of creating the file by using two keywords as well as assigning a file name, such a case is assumed where the saving area is set to the I drive, the management time is set to Jan. 1, 2004, two keywords are set to key 1 and key 2, the file name is set to filename1 input through the file name input selection box 63, and the file type is set to a word processing document having the extension of doc. In this case, in the information processing apparatus, I:\2004/1/1\key1\key2\filename1.doc is assigned as the path information of the file. Herein, the information processing apparatus arranges and manages all of the files in the I drive in the time-management sequence, as described above, but automatically assigns the present time of the creation time as the management time at the time of creating the file. Therefore, the creation time, the update time, and the management time of the file are all set to Jan. 1, 2004. Herein, the management time does not have to be a simplified transcription of a year, a month, and a day. The information processing apparatus manages the files to a unit of seconds using a serial value, thereby being able to eliminate the files that have the same path information and are therefore recognized as the same file. Therefore, the information processing apparatus can save the plurality of files each having a different management time and the same name, thereby being able to manage the same files based on update histories.

Furthermore, as an example of creating the file without assigning any keywords or file names, such a case is assumed where the saving area is set to the I drive, the management time is set to Jan. 2, 2004, the file name is set to no title as a default value displayed through the file name input selection box 63, and that the file type is set to a word processing document having the extension of doc. In this case, in the information processing apparatus, I:\2004/1/2\nontitle.doc is assigned as the path information. In the information processing apparatus, as described above, assignment of the keyword is arbitrarily selectable, so that the keyword is not necessarily forced to be assigned. Furthermore, in the information processing apparatus, the file name can also be set to the arbitrary condition by setting a default value. In the meantime, in the information processing apparatus, even where the plurality of files having no file names are created, those files are not recognized as the same file since the management time, the keyword, and the like change. As described above, the information processing apparatus can narrow down the files according to the management time and the file format even where the keyword does not exist, and further can seek and extract only the files having no file names.

Furthermore, as an example newly assigning only the keyword after creation of the file, such a case is assumed where the new keyword key3 is assigned to Jan. 3, 2004 on the condition that the path information before assignment of the new password is set to I:\2004/1/1\key1\key2\filename1.doc. In this case, in the information processing apparatus, I:\2004/1/1\key1\key2\key3\filename1.doc is assigned as the path information of the file. In the information processing apparatus, as described above, the keyword assigned to the file is displayed in another color at the time of selection of the file, and a keyword desired to be added is selected through the predetermined save and editing screen, so that the keyword can be changed. At this time, the creation time, the update time, and the management time are set to Jan. 1, 2004 in a manner similar to those before assignment of the keyword 3. That is, in the information processing apparatus, the creation time and the update time are not changed in a manner similar to as shift of the file using the existing Explorer and the management time is basically not changed.

Furthermore, as an example such that only the keyword is deleted after creation of the file, such a case is assumed that the keyword key3 is deleted on Jan. 4, 2004 on the condition that the path information before deletion of the keyword is set to I:\2004/1/3\key1\key2\key3\filename1.doc. In this case, in the information processing apparatus, I:\2004/1/3\key1\key2\filename1.doc is assigned as the path information of file. In the information processing apparatus, as described above, the keyword assigned to the file is displayed in another color at the time of selection of the file and selection of the keyword desired to be deleted is canceled through the predetermined save and editing screen, so that the keyword can be changed. At this time, in the information processing apparatus, the creation time and the update time are not changed while the management time is not to be changed as well in a manner similar to those at the time of assignment of new keyword.

Furthermore, as an example of overwriting and saving the updated file, such a case is assumed where the file is overwritten and saved on Jan. 5, 2004 on the condition that the path information before the overwriting and saving operation is set to I:\2004/1/1\key1\key2\filename1.doc. In this case, in the information processing apparatus, I:\2004/1/5\key1\key2\filename1.doc is assigned as the path information of the file. In the information processing apparatus, at the time of updating the file, either one of “overwrite save” or “save as another file” can be selected, and new information is written over old file information to update the management time and update time in the case of selection of the “overwrite save”. Thus, the creation time of the file remains as Jan. 1, 2004 but both the update time and the management time are set to Jan. 5, 2004.

Furthermore, as an example such that the updated file is saved as another file, such a case is assumed that the file is saved on Jan. 6, 2004 on the condition that the path information before the saving operation is set to I:\20041/1\key1\key2\filename1.doc. In this case, the information processing apparatus saves the file having the path information set to I:\2004/1/6\key1\key2\filename1.doc other than the file having the path information set to I:\2004/1/1\key1\key2\filename1.doc. That is, the information processing apparatus saves two types of files having different management times and update times in the case of selection of “save as another file” at the time of updating the file. At this time, in the information processing apparatus, the management time and the update time of the newly created file are updated, but the creation time thereof is not changed. That is, in this case, the creation time of the file remains as Jan. 1, 2004 but both the update time and the management time are set to Jan. 6, 2004. Thus, the information processing apparatus can manage the files based on histories by saving two types of files having the same file names but different management times.

Furthermore, as an example of a file being copied, such a case is assumed where the file is copied on the Jan. 7, 2004 on the condition that the file as a source has the path information set to I:\2004/1/1\key1\key2\filename1.doc. In this case, the information processing apparatus saves the file having the path information of I:\2004/1/7\key1\key2\filename1.doc other than the file as the source, having the path information of I:\2004/1/1\key1\key2\filename1.doc. That is, to copy the file, the information processing apparatus creates the file different from the source, being different from the source in the management time only. At this time, the information processing apparatus updates only to the management time of the copied file but does not change either the creation time or the update time thereof since the contents of the copied file are not updated from the source. In this case, that is, the creation time and the update time of the file remain as Jan. 1, 2004 but the management time thereof is set to Jan. 7, 2004. As described above, the information processing apparatus can manage the files based on histories by saving two types of files having the same file names but different management times.

Furthermore, as an example such that the time-period specification deselection button 53 is selected, such a case is assumed that the time-period specification deselection button 53 is selected on Jan. 8, 2004 on the condition that the path information of the file is set to 2004/1/1\key1\key2\filename1.doc. In this case, the information processing apparatus saves the file assigned with the path information set to I:\A2004/1/1\key\key2\filename1.doc. As described above, in the case of selection of the time-period specification deselection button 53, in the information processing apparatus, “A” is assigned at the front of the management time to set the management time of the files to the future with respect to the file having the newest management time, thereby being able to select and display the files having the future management time separately at once. In the meantime, selection of the time-period specification deselection button 53 is not associated with saving of the file, so that the creation time, the update time, and the management time are not changed. On the other hand, in the information processing apparatus, in the case of canceling selection of the time-period specification deselection button 53, the path information is reset to I:\2004/1/1\key1\key2\filename1.doc.

Furthermore, as an example of selecting the non-display button 54, such a case is assumed where the non-display button 54 is selected on Jan. 9, 2004 on the condition that the path information is set to I:\2004/1/1\key1\key2\filename1.doc. In this case, the information processing apparatus saves the file assigned with the path information set to I:\2004/1/1\\key1\key2\filename1.doc. As described above, in the case of selection of the non-display button 54 of the information processing apparatus, “\” is assigned after the management time, thereby being able to bring this file in non-display state. Thus, the information processing apparatus can eliminate such a possibility that the information indicating a non-display state as described above is confused with a keyword. In the case of selection of the non-display unit 54, the information processing apparatus does not change the creation time, the update time, and the management time. Thus, the information processing apparatus can retain the previous management time information at the time of selection of the non-display reset button 55, thereby being able to conduct the seeking operation at each time, so that the file can be redisplayed immediately. On the other hand, in the case of selection of the non-display reset button 55, the information processing apparatus resets the path information to I:\2004/1/1\key1\key2\filename1.doc.

Furthermore, as an example of sending the file saved to the I drive to another drive such as the C drive, such a case is assumed where the path information of the file is set to I:\2004/1/1\key1\key2\filename1.doc. In this case, the information processing apparatus saves the file assigned with the information of the designation folder as the path information, for example, C:\MyDocument\filename1.doc. That is, where the file is sent to a drive other than the I drive, the information processing apparatus handles the file in a manner similar to the conventional file system, so that change of the data is not accompanied and a concept of the management time becomes nonexistent. On the other hand, as an example of sending the file saved in another drive to the I drive, such a case is assumed where the file is sent on Jan. 10, 2004 on the condition that the path information of the file is set to C:\MyDocument\filename1.doc. In this case, the information processing apparatus saves the file assigned with the path information set to I:\2004/1/10\filename1.doc. That is, the information processing apparatus basically assigns the update time as the management time to the file at the time of sending the file to the I drive. At this time, the information processing apparatus activates the save screen to confirm assignment of the keyword at every time of sending the file to the I drive. In the case of not assigning the keyword, the information processing apparatus sets the sending date when the file is sent to the management time but does not change the update time. Furthermore, the information processing apparatus sets the sending date to the management time and the update time in a case of assigning the keyword.

As described above, the information processing apparatus can save the file by assigning various conditions to the path information through the save screen.

Next, a seek screen for seeking and displaying the file saved through the save screen will be explained.

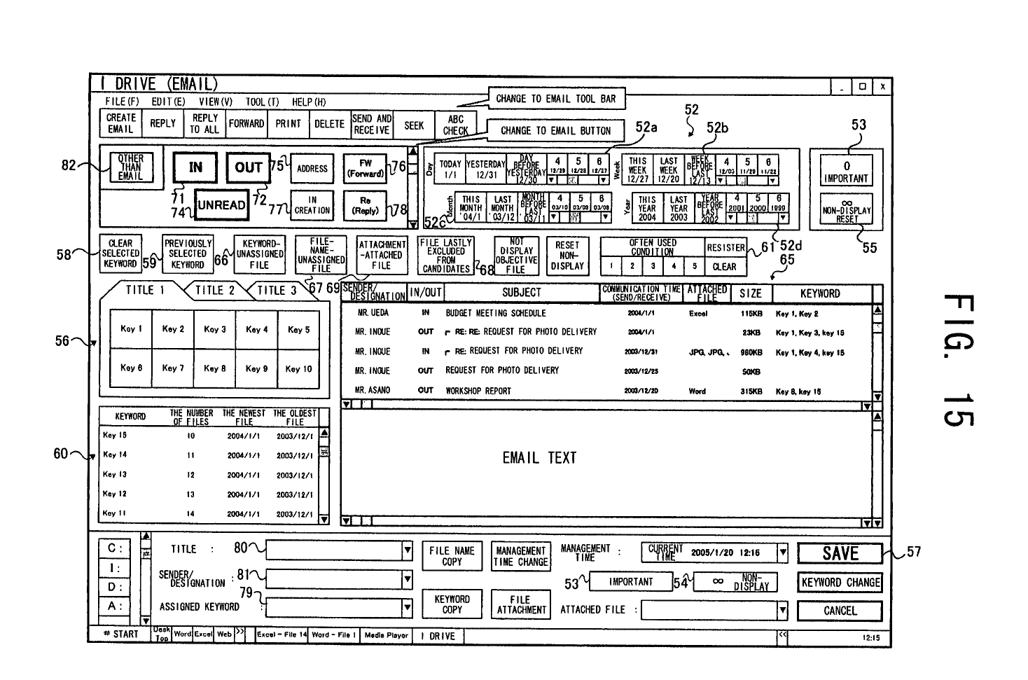

The information processing apparatus executes the predetermined file browser (seeking) software under control of the CPU11 and displays as the seek screen the GUI as shown in FIG. 14, for example, on the display unit 17. The seek screen is constructed in a manner similar to the save screen except that the seek screen does not have the file name input selection box 63, the file type input selection box 64, and the like. Each of the buttons that are the same as those in the save screen have a function of selecting a condition for performing the seeking operation, instead of a function of assigning a condition in the save screen.

To be more specific, in the information processing apparatus, the types of files as a seek objective are narrowed down with reference to the extension registered at the rightmost end of the path information by selecting the program button 51, thereby displaying the objective files on an objective file display area 65, in a a list or icon format. At this time, the information processing apparatus does not select the file type for each of the extensions in a manner similar to the conventional seeking system but extracts collectively the files having an extension executable with the application program corresponding to a selected button. With the information processing apparatus, the user can customize the extension which is sought with use of each program button 51, and can select the detailed file type based on a pop-up display, for example, by a right-click operation in the seeking operation.

Herein, in the information processing apparatus, an email file to be described later is set to a seek objective only where an email button 51a is selected, while a normal file is set to a seek objective where the buttons other than the email button 51a are selected. The information processing apparatus sets all of the files other than the email to a seek objective where none of program buttons 51 are selected. Furthermore, in the information processing apparatus, the predetermined key such as a control key is pushed while the plurality of program buttons 51 are single-clicked, so that union of sets (AUB) of the plurality of selected file types are set to a seek objective, and thus the files corresponding to the union of sets are displayed as the seek objectives in a a list or icon format on the objective file display area 65. Yet further, the information processing apparatus selects the set B in the difference of sets (A-B) by a single-click of the desired program button 51 as well as push of the predetermined key such as an Alt key so the seek objective does not include the corresponding objective.

In the meantime, in the information processing apparatus, the email is distinguished from the normal folders on ground of having different property information. To be more specific, the information processing apparatus does not display the email except in the case of selection of the email button 51a, while displaying only the emails by starting an email-only screen to be described later in the case of selection of the email button 51a. In the information processing apparatus, a screen for selecting the normal keyword is shared between the normal file and the email. This is because email is the nerve center of current business operations in many cases and there are many similarities between the normal file classification and the email classification.

In the information processing apparatus, furthermore, the files as the seek objective are narrowed down with reference to the management time registered in the path information by selecting the time-period specifying button 52, thereby displaying the objective files in a a list or icon format on an objective file display area 65. In the information processing apparatus, since the files inside the I drive are all arranged in the sequence of management time, not the whole of files but only files in an objective range, such as “from “I:\2004/1/1*” to “I;\2003/11/1*” ”, are to be sought and extracted, thereby being able to shorten the seeking time period. At this time, the time period of seeking the objectives starts from the time of a default setting or a previous termination.

Herein, there conventionally exists a seeking method in consideration of the time condition described above, such as a seeking method of directly inputting a year, a month, and a day, with the purpose of specifying the date. The seeking method, however, requires time to specify the date, and especially requires input of start and end of the time-period to specify the time-period, thereby having such a defect as forcing the user to perform a complicated input operation. The time-period specifying button 52 enables the seeking operation that is much easier to use than the conventional seeking method in consideration of time information.

Furthermore, in the information processing apparatus, the important files having importance that is unchangeable over time and the normal files narrowed-down by the time-period specifying button 52 are sought by selecting the time-period specification deselection button 53, thereby being displayed in a a list or icon format on the objective file display area 65. In the information processing apparatus, the important file is not displayed on the objective file display area 65 in a case where the time-period specification deselection button 53 is not selected. The information processing apparatus basically sets the time-period specifying button 52 to an unselected state and displays only the important files on the objective file display area 65, by a double-click of the time-period specification deselection button 53. At this time, the information processing apparatus can display by specifying the time period, only the important files having “A” assigned at the front of the management time in the path information, by sharing the time-period specifying button 52.

Furthermore, in the information processing apparatus, by selecting the non-display reset button 55, the files set to an unselected state by the non-display button 54 in the saving operation and the normal files narrowed-down by the time-period specifying button 52 are displayed in a list or icon format on the objective file display area 65. Yet further, in the information processing apparatus, a double-click of the non-display reset button 55 fixes selection thereof, so that only the non-display files are displayed on the objective file display area 65. At this time, in the information processing apparatus, only the non-display files having the management time corresponding to the time-period specifying button 52 and having the path information containing “\ \” after the management time are displayed on the objective file display area 65.

Furthermore, in the information processing apparatus, the keyword selection button 56 or the movable keyword selection area 60 are selected to seek and display the files including the selected keyword on the objective file display area 65. In the information processing apparatus, the files including the selected keyword are sought at every time, so that there is no need for selecting all of the keywords composing the path information, and the sequence of selecting the keywords and the choice as to whether or not to select the keywords are arbitrary. At this time, in the information processing apparatus, as described above, since the files are sought by setting such a portion to a unit, as sandwiched between “\”, for example, “\keyword A\”, other keywords containing “keyword A” are not extracted despite the existence thereof, thereby being able to prevent the seeking operation from becoming unclear. Furthermore, in the information processing apparatus, since the file name is not sandwiched between “\”, even where the file name contains the keyword, the file name is not displayed as a candidate file as a mistake on the objective file display area 65 as long as the keyword is not assigned to the path information. In the information processing apparatus, the plurality of keywords can be selected at the same time by a single-click of the plurality of keyword selection buttons 56 or the movable keyword selection area 60. In this case, a product of sets (A∩B) of the plurality of selected keywords is set as the seek objective, and the files including all of the plurality of selected keywords are displayed as seek results in a a list or icon format on the objective file display area 65 in a form. Furthermore, in the information processing apparatus, the predetermined key such as a shift key is pushed while the plurality of keyword selection buttons 56 or the movable keyword selection area 60 are single-clicked, so that a union of sets of the plurality of selected file types is set as the seek objective, and as seek results, the files containing any one of the plurality of selected keywords are displayed as an objective file in a list or icon format on the objective file display area 65. Furthermore, in the information processing apparatus, the predetermined key such as a shift key is pushed while the plurality of keyword selection buttons 56 or the movable keyword selection area 60 are single-clicked, so that a difference (A∪B)-(A∪B) between a union of sets (A∪B) and a product of sets (A∩B) is set to the seek objective, and as seek results, the files containing any one of the plurality of selected keywords are displayed in a list or icon format on the objective file display area 65. Yet further, in the information processing apparatus, the predetermined key such as a shift key is pushed while the plurality of keyword selection buttons 56 or the movable keyword selection area 60 are single-clicked, so that the set B in a difference of sets (A-B) does not contain the corresponding objectives in the seek results.

In the information processing apparatus, all of the selected keyword selection buttons 56 can be reset to an unselected state by a single-click of the keyword clearance button 58, while the keyword selection buttons 56 that were selected at the time of the previous saving operation can be set to a selected state by a single-click of the previous keyword selection button 59. Furthermore, in the information processing apparatus, only the files to which the keyword is not assigned as a condition are displayed as objective files in a list or icon format on the objective file display area 65 by a single-click of a keyword-unassigned file button 66, and only the files to which a file name is not assigned are displayed as the objective files in a list or icon format on the objective file display area 65 by a single-click of a file-name-unassigned file button 67.

Furthermore, the information processing apparatus is provided with an elimination objective display button 68 for displaying the objective files that were eliminated from the candidates in the last condition selection operation. In the information processing apparatus, there is a risk that the user cannot visually identify such a file as omitted from the candidates in the case of selection of one more condition since the file is hidden behind numerous other candidates. Therefore, the information processing apparatus is provided with the elimination objective display button 68 to enable display of the files omitted from the candidates in the last condition selection operation. The information processing apparatus can thereby reduce leakage at the time of the seeking operation.

Furthermore, the information processing apparatus broadens the concept of attaching the file to an email, thereby realizing attachment of another file to a normal file. For example, a main document created using a word processing document and a sub-document created using a spreadsheet software exist as a conference material, having contents supplementing the main document, in many cases where the user desires to correlate and save two or more files. The function of attaching another file to the normal file is extremely effective in the use described above.

Two pieces of information are necessary for realizing the file attachment function, that is, one is as to whether the file is attached and the other is, if the file is attached, as to whether the file is saved. In other words, the file can be attached without control of the relation database, as long as certain rules and property information are prepared.

To be more specific, the information processing apparatus is required only to attach the information indicating existence of a child file to the path information of a parent file and to uniquely decide in advance specific saving areas such as areas not allowing the normal files to be saved thereto by using forbidden characters, currently-used Temp folders, and the like, so the attached child file is not affected by the update of the parent file. The information processing apparatus can thus correlate and save the arbitrary files. Furthermore, in the case of seeking the files attached with the aforementioned attachment files, the information processing apparatus can display those files on the objective file display area 65 in a list or icon format by selection of an attachment-attached file button 69. In this case, it goes without saying that the child file is set in a manner that the unique keyword cannot be assigned thereto.

As described above, the information processing apparatus can easily attach the relative file to the arbitrary file as the relative documents are stapled.

Hereinafter, an email software program for sending and receiving emails will be explained as another specific example of the application software program executable by the information processing apparatus.

In using the conventional email software program, the relational database is used for management of emails in many cases, and emails are generally managed on a folder basis or on an overall file basis, which compiles emails, since the pieces of information on individual emails need to be listed to manage the emails. That is, since the email has higher volume of different property information than that of the normal file and the conventional file browser software program such as Explorer lacks a database function sufficient to handle the emails, a single file is created for each of the email folders, similar to a so-called DBX box, thereby being handled by using a specific software program. On the precondition that the emails are classified and saved to individual folders, where the folder increases in capacity enough to cause a slowdown in the processing speed, the user is considered as responsible, so that it is recommended to divide the folders where a certain volume of emails are accumulated therein. However, even the emails are not necessarily managed by the specific email software program but can be managed by another program as long as the program has a function of sending and receiving files. The high quality email software program depends not on an excellent function of sending and receiving files but on a function for finding the target file immediately and on an excellent database function that is easily manageable.

Since the information processing apparatus applies a method such that all of the files are not classified but compiled at one place to be managed, as described above, this thought is developed to handle the individual files to be sent and received as an independent sole file, and a communication time such as a receiving time or a sending time of the email is used as the aforementioned management time. Thus, the information processing apparatus can handle the emails as well in a manner similar to the aforementioned normal file. As described above, the emails, however, have property information different from that of the normal file, thereby being required to be distinguished therefrom. The information processing apparatus executes the predetermined email application program using the CPU 11 to display as the email screen the GUI, such as that shown in FIG. 15, on the display unit 17 where the email button 51a is provided to the save screen or the seek screen. That is, the information processing apparatus displays the GUI that visualizes a function of selecting various conditions on the display unit 17 in a manner similar to the save screen or the seek screen.

To be more specific, the email screen is provided with the time-period specifying button 52, the time-period deselection button 53, the non-display button 54, the non-display reset button 55, the keyword selection button 56, the keyword clearance button 58, the previous keyword selection button 59, the movable keyword selection area 60, the condition selection shortcut key 61, the keyword display area 62, the keyword-unassigned file button 66, the file-name-unassigned file button 67, the elimination objective display button 68, and the attachment-attached file button 69, as shown in FIG. 15. Those various operating elements have substantially the same function as those of the save screen or the seek screen as described above.

Especially in the keyword selection button 56 and the movable keyword selection area 60, other than the keywords indicating the contents of the email, the email address or the like of the party at the other end is registered as the keyword. Herein, in all of the conventional email software programs, management is conducted on an individual email basis. On the other hand, the information processing apparatus can classify the emails based on a condition as an arbitrary selection item, thereby being able to conduct a topic management that has not been conducted, even using any type of email software program. In many cases, the emails concerning a single topic are received and sent two or more times, a plurality of parties exist, or, even in the case of the same partner at the other end, the emails concerning another topic are sometimes received and sent during intervals between communications with respect to a single topic. Therefore, it is extremely difficult to extract afterward all of the emails concerning a single topic. Furthermore, in using the conventional email software program, contiguous sequence of the emails is interrupted unless a return function is used, or in the case where a title is not assigned to the email, a title irrelevant to content is assigned, or where two or more topics are in the same single email, the contents cannot be determined based on the tile, so that the user needs to read the contents for confirmation every time. Herein, the information processing apparatus manages topics by registering a topic of the email as a keyword in the keyword selection button 56 or the movable keyword selection area 60, thereby being able to remarkably shorten the seeking time-period. In the meantime, the topic is defined as a condition of an arbitrary selection condition, thereby not interfering with the operation for seeking individual emails. Furthermore, in the case where the contents of the single email are composed of two or more topics, the email can be registered in the plurality of topics or conversely, such emails not classified based on topic can be created.

Furthermore, this email screen is provided with an in-button 71 and an out-button 72 respectively corresponding to a so-called conventional inbox where the received email is saved and an outbox where the sent email is temporally saved. That is, the information processing apparatus is not provided with the folders such as the inbox and the outbox which were taken for granted in using the conventional email software program but provided with the in-button 71 and the out-button 72 instead, and registers the files of the received email and the sent emails in the in-button 71 and the out-button 72, respectively. The information processing apparatus seeks either one of the received emails or the sent emails as an objective email according to selection of either one of the in-button 71 and out-button 72, thereby displaying the sought emails on an objective email display area 73 in a list or icon format. The information processing apparatus can therefore easily select classification between the received email and the sent email, as a condition. Therefore, the information processing apparatus can narrow the emails down to the emails belonging to either one of the received email or the sent email by adopting this method, thereby making it easy to seek the targeted email while confirming the histories.

The email screen is further provided with an unread button 74 for selecting the email which is not yet read. The information processing apparatus seeks only the unread emails as an objective email according to selection of the unread button 74, thereby displaying the sought emails on the objective email display area 73 in a list or icon format.

Other than that, the email screen is provided with an address book selection button 75 for selecting a keyword as a condition from an address book, a forwarded-email selection button 76 for selecting only forwarded emails, an in-creation email selection button 77 for selecting only the emails which are in the process of creation, a sent email selection button 78 for selecting only the sent emails, and the like. The information processing apparatus seeks only the corresponding emails as the objective email according to selection of each of the various buttons, thereby displaying the sought emails on the objective email display area 73 in a list or icon format.

The information processing apparatus assigns via the aforementioned email screen a condition on the email file to be saved, thereby causing a keyword display area 79 to display the assigned keyword. Furthermore, with the information processing apparatus, a title of the email is input or selected via a title input selection box 80 or a sender or destination of the email is input or selected via a sender/destination input selection box 81 and thereafter the save button 57 is pushed so that the received or sent email is saved to the I drive. In the information processing apparatus, it is to be noted that the keyword is not necessarily assigned as a condition in a manner similar to that of the normal file, and the information processing apparatus is required only to assign as a condition a time-period selected via the time-period specifying button 52. With the information processing apparatus, furthermore, selection of a program button 82 causes a return to the save screen or the seek screen previously shown in FIG. 3 or 14.

As described above, the information processing apparatus can set the arbitrary selection item as a condition with respect to the email as well and perform extraordinary variety of classifications by handling those conditions as a set.

As described above, handling each of the emails as an independent file results in merits such as described hereinafter.

First of all, it becomes possible to easily pass the file and the address. With the information processing apparatus, the email can be passed as well between different application software programs so a text file as to be readable using various application software programs. Furthermore, with the information processing apparatus, the address is handled as an individual file, thereby being able to be passed in substantially the same manner. Second, it becomes easy to share the file. With the information processing apparatus, the email file can be shared by sharing the physical area for saving the file, and if this sharing is applied to groupware, large amounts can be easily shared, which is considered impossible. The seek screen can be easily customized in accordance with each of the users' needs, thereby not requiring expensive groupware. To be more specific, in the information processing apparatus, only the email having a user's own name as a sender and receiver is normally set to a seek objective and the other emails are to be sought if necessary. This can be applied to others besides email. Third, the keyword can be shared. Since the email presently plays a central role in business operations, it is more convenient to set classification of the emails to be equal to classification of the normal files, but a management software program for an email is different from a management software program for a normal file, so that the sharing of classification cannot be realized. With the information processing apparatus, however, as described above, function of the email software program is rendered to coalesce in the save screen or the seek screen, thereby allowing commonality of each keyword. Thus, the information processing apparatus can easily manage projects or cases and shorten remarkably a time required for seeking for and/or managing the file or the email.

As described above, the information processing apparatus according to the embodiment of this invention shakes off a concept of conventional file management based on a fixed hierarchical structure in a tree form and adopts a concept of a condition set to perform a file management in which the path information is recognized as a condition set, thereby being able to sought the corresponding file from among various conditions easily and accurately, thereby being able to provide the user with remarkably high convenience.

It is to be noted that this invention is not limited to the aforementioned embodiment. For example, the image processing apparatus is structured as a personal computer, for example, in the above embodiment but this invention can be applied to a mobile computer requiring file management, such as a cellular phone or Personal Digital Assistants (PDA).

Furthermore, this invention is suitable for application not only to the stand-alone information processing apparatus but also to groupware or the like. Under the file management using the conventional saving area, it is not easy for the third party other than the person who saved the file to seek the target file, thereby leading to a situation such that the information is hardly shared in the business scene. According to this invention, a selection item as a condition is consistently set for an organization and the necessary selection item is laid down, so that any users who belong to the organization can easily find out the file saved by the others, thereby being able to operate and manage the information as an organization. According to this invention, furthermore, the seek screen handled by each individual can be arbitrarily customized in accordance with needs, thereby no longer requiring the expensive groupware, and since the condition setting as an individual is set to an arbitrary selection item, the identical file to be shared can be managed in the user's unique way as well as by using his keyword that is different from others.

Furthermore, according to this invention, the GUI for selecting a condition composing the save screen, the seek screen, and the email screen is not limited to a button form but can be arbitrary.

To be more specific, the button form is a fixed type in substantially the same form as a shortcut formed on a desktop. This type of button form can always be displayed in the same area to render the keywords few in number, thereby being effective in the case where those keywords are fixed and simple regardless of a time lapse. On the other hand, the but ton form is unsuitable in the case where the keyword is composed of a long character string, there are a large number of keywords, or where the number of keywords increases frequently.

The GUI can adopt a tabular form defined as movable, which is the same form as that of file display in using the existing Explorer. The tabular form is effective in the case where the keywords are high in number or where the number of keywords increases frequently, upon sorting or use of a filter function. Furthermore, where the keyword depends on a time lapse, the tabular form is used in combination with the time-period specifying button 52 to bring the old files to a non-display state or to display only the files including the keyword of the specific time period, thereby facilitating the seeking operation. Furthermore, it is also possible to manage the keyword of a tabular form by using the keyword in a form of a button or a tree. The aforementioned tabular form is effective not only for management of project cases or monthly or yearly file management but also for a new method for managing emails in a manner to compile the emails based on topic.

Furthermore, the GUI can adopt a fixed type of foldable tree form in substantially the same form as the folder forming a hierarchical structure in the conventional tree form. The aforementioned tree type is such a method for developing a scheme while minutely classifying the keyword from top down. That is, the tree form is a method extremely suitable for keyword management. In the conventional tree form, as the area for saving the file, only one of the keywords formed in a hierarchical structure had to be selected as an absolute condition, so that the conventional tree form was not suitable as a file management method. That is, a screen for managing the keyword and the area for saving the file are combined, thereby going beyond capacity. The advantage in using the tree form is that in the case of existence of a concept such as high and low levels, simplification can be achieved at the time of assignment of the keyword by setting the keyword to a higher keyword to be selected at the time of selection of a lower keyword. Furthermore, the tree form is foldable, thereby being able to manage easily a greater number of keywords than the button form. Furthermore, at the time of introducing this invention, the tree form can be structured in substantially the same manner as the screen which has been familiar so far, so that the user feels comfortable, thereby being able to directly use the existing classification of the file as a keyword.

Furthermore, the GUI can adopt a hyperlink form that can be freely placed. In using the hyperlink form, the operation elements can be freely placed, thereby being able to compose various screens such as a web screen with use of HTML (Hyper Text Markup Language).

For example, according to this invention, a flow chart can be directly used as the GUI for selecting a condition and, in this case, it becomes possible to seek the file according to stages of operational progress with ease. Furthermore, in this invention, a Gantt chart also can be directly used as the GUI for selecting a condition and in this case, the file can be managed according to stages of progress such as development of a game, a project of a general contractor, and the like, so that it becomes easy for the plurality of parties concerned to share the information. At this time, in this invention, where the GUI for selecting a condition is created by directly using the flow chart or the Gantt chart, the project name is specified as a condition, thereby being able to ascertain whether a document (file) in accordance with the flow chart or the Gantt chart is created to follow up the project. For example, according to this invention, the GUI for selecting a condition is created by directly using a flow chart such as “a proposal”→“a specification”→“an estimate”→“an invoice”, it becomes possible to seek the file according to stages of operational progress with ease and further, the project name is designed in a selectable manner to allow display of the objective file by specifying and selecting the project, thereby being able to easily ascertain whether the document is created in accordance with a flow chart. It is to be noted that the project name is desirably set to a movable condition such that the sorting in the sequence of date or the Japanese syllabary is possible, not to the fixed button form. Therefore, according to this invention, the projects can be sought by sorting in the sequence of date of the Japanese syllabary even where the project number increases, thereby being able to easily seek the projects requiring follow-up.

Furthermore, according to this invention, a bookkeeper or the like at the company can be prevented from forgetting to create the document by creating the GUI for selecting a condition as formed in a form of a calendar or a schedule book, which expresses the operation for creating the document, in the case where there exists the document that has to be created by an appointed date of each month, for example. According to this invention, furthermore, the schedule book is provided with specification on a weekly basis, on a monthly basis, and a yearly basis, such as by the tenth of each month, and with specification based on the actual date to allow the date to be specified by selecting either one, so that the business operation schedule can be managed with respect to the files. Yet further, according to this invention, where a teacher gives an assignment to students or where a supervisor demands that his subordinates submit a document, specifying those date conditions enables the submission deadline to be respected. Furthermore, according to this invention, managing the emails using such the GUI for selecting the condition as formed in a calendar form makes it easy to seek the emails having dates by which received email must be answered or sent email must be responded to and further, registration of the anniversary or the like enables users to be prevented from forgetting to transmit the important emails.

Furthermore, this invention can be applied to the existing address book. That is, the existing address book is managed by the folder forming a hierarchical structure in a tree form in many cases. According to this invention, the candidates can be easily reduced by adding a condition as an arbitrary selection item onto the address book. At this time, this addition of a condition is arbitrary, thereby not interfering with seeking in the sequence of the Japanese syllabary. For example, according to this invention, the candidates can be reduced in half only by setting classification between men and women. Furthermore, according to the invention, classification of age of the person at the other end, such as older, the same, or younger with respect to the user himself, or a physical size of the person at the other end, such as taller, shorter, or fat, is suitable as a condition because those statuses are comparatively retained in memory. Furthermore, according to the invention, where the physical size or feature of the person at the other end, such as wearing grasses, wearing a beard, or having long hair, is set to a condition, the buttons for selecting those conditions are assigned with illustrations, thereby being able to provide those buttons as a highly amusing seeking tool. Yet further, according to this invention, the address book is directly created as the GUI for selecting a condition with respect to information on customers such as a doctor, a company, and the like, so that customer data, the document submitted to the customer, and the like can be promptly extracted.

According to this invention, furthermore, the album can be directly created as the GUI for selecting a condition, which is similar to the address book. For example, according to this invention, where a teacher at a private school needs to remember names of students or a supervisor needs to remember names of subordinates at a new workplace, the album of facial portraits are directly used to create the GUI for selecting a condition, thereby being able to confirm the identification of person in a manner to correlate the document with the person.

According to this invention, furthermore, the organization chart is directly created as the GUI for selecting a condition. For example, management using the organization chart makes it easy to seek human resources data, budget management, and the like of the organization. Furthermore, according to this invention, the relationship diagram is directly created as the GUI for selecting a condition. For example, where a detective manages information concerning a background, alibi, and investigation of people involved in a case, management using a personal relationship diagram makes it easy that the user manages the document while organizing the information. Furthermore, according to this invention, the graph can be directly created as the GUI for selecting a condition. According to this invention, for example, the information as to quality of the branch office can be performed by creating the graph directly as the GUI for selecting a condition.

According to this invention, furthermore, a map or a route map can be created directly as the GUI for selecting a condition. A real-estate agent and the like can find out information on a real estate property by managing the file based on the map. Furthermore, a franchisee having a plurality of branch offices manages the files concerning sales, purchase, and the like, thereby being able to performing a marketing analysis at the same time. According to this invention, furthermore, a design drawing can be created directly as the GUI for selecting a condition. Those concerned in a design, a construction company, an interior finish work, and the like manage the files using the drawing of building, thereby being able to extract material cost estimates, 3-D images, conceptual views, or the like for that place. An author of historical novels, a historian, and the like create a chronology directly as the GUI, thereby being able to extract materials for each of the chronologies. Furthermore, according to this invention, a statement of accounts can be created directly as the GUI for selecting a condition. According to this invention, the statement of accounts is created directly as the GUI so as to promptly seek materials concerning a corresponding item of account, thereby being able to realize an easy audit.

As described above, according to this invention, various operation elements, backgrounds, and the like can be freely designed differently from the conventional folders forming a hierarchical structure in a tree form, thereby being able to design and create unique user interfaces in accordance with a business operation or an objective. Furthermore, according to this invention, in the case of using the background having unclear grids, such as a map or a design drawing, time and trouble are required to embed the condition selection buttons in those grids. Herein, according to this invention, a screen is partitioned at a certain spacing and classified in each of platting papers of a predetermined area to display the number of files to manage the files, which is defined as a method applied to the existing atlases, so that time and trouble required to assign the condition selection buttons can be omitted.

As described above, this invention is based on a totally new concept such as the user interface in accordance with business-operation contents or creation of an idea about management of the business operation by the user interface.

As described above, this invention can be arbitrarily modified without departing from the scope thereof.

1. An information processing apparatus comprising:
a save screen display controlling section for displaying on a display section a save screen for saving a file to a predetermined saving section;
a first condition specifying section for specifying a condition to be assigned to the file via the save screen displayed on the display section;
a save processing section for assigning each condition assigned by the first condition specifying section to path information of the file and for saving the file to the saving section;
a seek screen display controlling section for displaying on the display section a seek screen for seeking and displaying the file saved to the saving section;
a second condition specifying section for specifying a condition of the file as a seek objective via the seek screen displayed on the display section;
a seek processing section for recognizing the path information of the file saved to the saving section, as such a condition set as allowing a selection sequence to be changeable and as having each condition set to an arbitrary selection item, the seek processing section for seeking for an objective file corresponding to a calculation result of the condition set based on a condition specified by the second condition specifying section; and
a result display controlling section for displaying on the display section the objective file as a seek result by the seek processing section.

2. The information processing apparatus according to claim 1, wherein the save screen is provided with a first keyword-only operation element for specifying as a condition a keyword arbitrarily set by a user, wherein the seek screen is provided with a second keyword-only operation element for specifying as a condition a keyword corresponding to the first keyword-only operation element displayed on the save screen, wherein the save processing section assigns as a condition a keyword registered in the first keyword-only operation element, specified via the first condition specifying section, to the path information of the file, and saves the file to the saving section, and wherein the seek processing section seeks the objective file corresponding to the computation result of the condition set, based on a keyword as a condition registered in the second keyword-only operation element, specified via the second condition specifying section.

3. The information processing apparatus according to claim 2, wherein the first keyword-only operation element and the second keyword-only operation keyword both have such a fixed keyword registered therein, as uninfluenced by a time factor and such a movable keyword registered therein, as influenced by a time factor.

4. The information processing apparatus according to claim 1, wherein the save screen is provided with a first management time-only operation element for specifying as a condition a management time of the file, wherein the seek screen is provided with a second management time-only operation element for specifying as a condition a management time corresponding to the first management time-only operation element displayed on the save screen, wherein the save processing section assigns as a condition a management time registered in the first management time-only operation element specified via the first condition specifying section, to the path information of the file, and saves the file to the saving section, and wherein the seek processing section seeks the objective file corresponding to the calculation result of the condition set, based on a management time as a condition registered in the second management time-only operation element specified via the second condition specifying section.

5. The information processing apparatus according to claim 4, wherein the first management time-only operation element and the second management time-only operation element are respectively configured with such a plurality of time divisions as arranged in parallel and as specifying a range of the management time.

6. The information processing apparatus according to claim 4, wherein the management time is defined as an update time of the file.

7. The information processing apparatus according to claim 4, wherein the save screen is provided with a deselection-only operation element for specifying a condition for displaying all files as the seek result regardless of specification of the management time by the first management time-only operation element, wherein the save processing section assigns as a condition a predetermined character string to the path information of the file according to selection of the deselection-only operation element via the first condition specifying section, and saves the file to the saving section, and wherein the seek processing section seeks as the objective file a file having the path information assigned with the character string, regardless of the management time as a condition registered in the second management time-only operation element, specified via the second condition specifying section.

8. The information processing apparatus according to claim 4, wherein the save screen is provided with a non-display-only operation element for specifying a condition for preventing display of a file as the seek result regardless of specification of the management time by the first management time-only operation element, wherein the save processing section assigns as a condition a predetermined character string to the path information of the file according to selection of the non-display-only operation element via the first condition specifying section, and saves the file to the saving section, and wherein the seek processing section excludes the file having the path information assigned with the character string from seek candidates regardless of the management time as a condition registered in the second management time-only operation element, specified via the second condition specifying section.

9. The information processing apparatus according to claim 8, wherein the seek screen is provided with a non-display reset operation element for redisplaying the file excluded by the seek processing section from the seek candidates based on the character string assigned to the path information.

10. The information processing apparatus according to claim 1, wherein the save screen is provided with a first type-only operation element for specifying a type of the file as a condition, wherein the seek screen is provided with a second type-only operation element for specifying as a condition a type corresponding to the first type-only operation element displayed on the save screen, wherein the save processing section identifies as a condition an extension registered in the path information of the file based on a type of the file registered in the first type-only operation element, specified via the first condition specifying section, and saves the file to the saving section, and wherein the seek processing section seeks the objective file with reference to the extension registered in the path information of the file, based on a type of the file as a condition registered in the second type-only operation element, specified via the second condition specifying section.

11. The information processing apparatus according to claim 1, wherein the save processing section assigns information indicating existence of a second file to be attached, to the path information of the first file, and saves the first file to the saving section while saving the second file to a specific saving area in the saving section.

12. The information processing apparatus according to claim 11, wherein the seek screen is provided with an attachment-attached file-only operation element for seeking for the first file attached with the second file, and wherein the seek processing section seeks the first file according to selection of the attachment-attached file-only operation element via the second condition specifying section.

13. The information processing apparatus according to claim 1, handles each of sent and received emails as an independent file, saves an email file to the saving section, and includes an email screen display controlling section for displaying on the display section an email screen for seeking and displaying the email file saved to the saving section, wherein the save processing section assigns each condition specified for the email file by the first condition specifying section, to the path information of the email file via the email screen displayed on the display section, and saves the email file to the saving section, and wherein the seek processing section seeks an objective email file corresponding to a calculation result of a condition set via the email screen displayed on the display section, based on a condition specified by the second condition specifying section.

14. A file management method comprising the steps of:
controlling and displaying on a display section a save screen for saving a file to a predetermined saving section;
specifying a first condition to be assigned to the file via the save screen displayed on the display section;
assigning each condition specified at the first condition specifying step to path information of the file and saving the file to the saving section;
controlling and displaying on the display section a seek screen for seeking and displaying the file saved to the saving section;
specifying a second condition of the file as a seek objective via the seek screen displayed on the display section;
recognizing the path information of the file saved to the saving section, as such a condition set as allowing a selection sequence to be changeable and as having each condition set to an arbitrary selection item, and seeking an objective file corresponding to a calculation result of the condition set based on a condition specified at the second condition specifying step; and
controlling and displaying on the display section the objective file as a seek result at the seek processing step.

15. A file management program executable by a computer, comprising the steps of:
controlling and displaying on a display section a save screen for saving a file to a predetermined saving section;
specifying a first condition to be assigned to the file via the save screen displayed on the display section;
assigning each condition specified in the first condition specifying process to path information of the file and saving the file to the saving section;
controlling and displaying on the display section a seek screen for seeking and displaying the file saved to the saving section;
specifying a second condition of the file as a seek objective via the seek screen displayed on the display section;
recognizing the path information of the file saved to the saving section, as such a condition set as allowing a selection sequence to be changeable and as having each condition set to an arbitrary selection item, and seeking an objective file corresponding to a calculation result of the condition set based on a condition specified in the second condition specifying process; and
controlling and displaying on the display section the objective file as a seek result in the seek process.

16. The information processing apparatus according to claim 2, wherein the save screen is provided with a first management time-only operation element for specifying as a condition a management time of the file, wherein the seek screen is provided with a second management time-only operation element for specifying as a condition a management time corresponding to the first management time-only operation element displayed on the save screen, wherein the save processing section assigns as a condition a management time registered in the first management time-only operation element specified via the first condition specifying section, to the path information of the file, and saves the file to the saving section, and wherein the seek processing section seeks the objective file corresponding to the calculation result of the condition set, based on a management time as a condition registered in the second management time-only operation element specified via the second condition specifying section.
